(19) United States
(12) Patent Application Publication
(10) Pub. No.: US 2025/0141997 A1
(43) Pub. Date: May 1, 2025

(54) SYSTEM FOR INTERNET-MEDIATED DIALOGUE

(71) Applicant: toraru Co., Ltd., Kobe-shi, Hyogo (JP)

(72) Inventor: Jun NISIGUCHI, Kobe (JP)

(21) Appl. No.: 18/689,651

(22) PCT Filed: Sep. 15, 2022
(86) PCT No.: PCT/JP2022/034650

§ 371 Date: Jan. 6, 2025

(30) Foreign Application Priority Data
Sep. 7, 2021 (JP) 2021-145716
Sep. 7, 2022 (JP) 2022-142591

(51) Int. Cl. H04M 7/00; G06Q 20/10

(52) U.S. Cl. CPC H04M 7/0027; G06Q 20/102

(57) ABSTRACT

A system is provided that allows users to engage easily in conversations over the Internet without the need for prior preparation. In the system, a service recipient (originating user) who wishes to receive an information service from an expert, for example, enters the URL of the call-in web page of the service provider (receiving user) into the web browser of their smartphone. By touching the “Call” button included in the call-in web page displayed on the web browser, he/she can trigger a continuous call tone or vibration on the service provider's smartphone, initiating the call. When the service provider touches the “Answer” button on his/her smartphone in response to the call, a conversation can be initiated between the service recipient's smartphone and the service provider's smartphone, allowing for communication through voice, video, and text.

### TECHNICAL FIELD

This invention relates to a system for dialogue over the Internet.

### BACKGROUND ART

A technology is known for providing services using a teleconferencing system. For example, Patent Document 1 proposes a system in which, through a teleconferencing system, headquarters staff provide business guidance upon request by agency staff, and the headquarters charges the agency fees based on the time spent on the guidance.

### PRIOR ART DOCUMENT

### Patent Document

Patent Document 1: JP2003-46966A

By using a teleconferencing system, various information provision services that were traditionally conducted face-to-face can be carried out without the need for direct in-person meetings. In such cases, no special space (such as an office meeting room) is required for providing the service. Additionally, neither the person providing the service (hereinafter referred to as the “service provider”) nor the person receiving the service (hereinafter referred to as the “service recipient”) needs to travel to meet.

When the service recipient uses a teleconferencing system to receive services from the service provider, the service recipient must contact the service provider via phone, email, or other means. The service recipient then receives a notification from the service provider containing the URL (Uniform Resource Locator) of a virtual meeting room and needs to access the meeting room identified by the notified URL using their terminal device. Additionally, when the service provider uses a teleconferencing system to provide services to the service recipient, the service provider must receive contact from the service recipient via phone, email, or other means, prepare a meeting room, notify the service recipient of the meeting room's URL, and access the meeting room identified by the notified URL using their own terminal device.

As described above, the exchange of services using a teleconferencing system requires prior preparation by both the service recipient and the service provider. Therefore, the service recipient cannot easily receive services on a whim. Additionally, the service provider cannot easily offer services during their free time when they have no other commitments.

In light of the above circumstances, the present invention provides a means that enables casual dialogue over the Internet without the need for prior preparation.

### SUMMARY

The present invention provides a system comprising: a web page transmission unit that, in response to a request from an originating terminal device equipped with a web browser function used by an unspecified originating user, transmits a call-in web page to the originating terminal device, which accepts a call operation directed to a receiving terminal device equipped with a telephone function used by the receiving user, a call instruction transmission unit that, when a call operation is performed by the originating user on the call-in web page displayed by the originating terminal device, transmits a call instruction to the receiving terminal device to initiate a call for the receiving user, and a communication enabling unit that, when the receiving user performs an operation to answer the call on the receiving terminal device being called in the same manner as a calling method used by the telephone function, enables communication for a conversation between the originating user using the originating terminal device and the receiving user using the receiving terminal device.

In an aspect of the above-mentioned system, payment information for settlement of a fee is transmitted from the receiving terminal device to the originating terminal device via the communication enabled by the communication enabling unit, and payment completion information, which indicates that a payment for a service provided by the receiving user to the originating user or a service requested by the originating user from the receiving user has been completed, is transmitted to the receiving terminal device via the communication enabled by the communication enabling unit.

In an aspect of the above-mentioned system, payment information for settlement of a fee for a service provided by the receiving user to the originating user or a service requested by the originating user from the receiving user is transmitted to the receiving terminal device via communication enabled by the communication enabling unit.

In an aspect of the above-mentioned system, the web page transmission unit transmits a payment page displaying payment information for settlement of a fee for a service provided by the receiving user to the originating user or a service requested by the originating user from the receiving user to the originating terminal device via the communication enabled by the communication enabling unit, the system further comprises a payment completion information reception unit that receives payment completion information from the originating terminal device, indicating that a payment has been completed using the payment information, and the call instruction transmission unit transmits the call instruction when the payment completion information reception unit has received the payment completion information.

In an aspect of the above-mentioned system, the web page transmission unit transmits a payment information request web page that asks for an input of payment information for settlement of a fee, the system further comprises a payment information reception unit that receives the payment information from the originating terminal device, and the system further comprises a payment unit that performs payment processing with an external device by communicating with the external device and carrying out the payment processing for a service provided by the receiving user to the originating user or a service requested by the originating user from the receiving user via communication enabled by the communication enabling unit.

In an aspect of the above-mentioned system, the call instruction transmission unit transmits the call instruction after the payment unit has completed the payment processing for the service with the external device.

In an aspect of the above-mentioned system, the system further comprises a timing unit that measures a duration of time of provision of the service, and the payment unit performs the payment processing for a fee for the service based on the time measured by the timing unit.

In an aspect of the above-mentioned system, the web page transmission unit, when receiving a request to transmit the call-in web page from the originating terminal device during a specified time period, transmits to the originating terminal device, instead of the call-in web page, a time-out notification web page notifying that the time period is not available for a call to the receiving terminal device to be made.

In an aspect of the above-mentioned system, the system further comprises a status information receiving unit that receives status information from the receiving terminal device indicating whether or not the receiving user is capable of providing a service, and the web page transmission unit, based on the status information received by the status information receiving unit, transmits, instead of the call-in web page, an interaction-unavailable notification web page notifying that the receiving user is unable to provide the service during a time when the receiving user is incapable of providing the service.

In an aspect of the above-mentioned system, the web page transmission unit, when receiving a request for transmitting the call-in web page from an originating terminal device used by an originating user while communication between another originating user and the receiving user is possible through the communication enabling means, transmits, instead of the call-in web page, an interaction-in-progress notification web page notifying that the receiving user is currently in a conversation with another originating user, to the originating terminal device from which the request is transmitted.

In an aspect of the above-mentioned system, the call instruction transmission unit, when communication between an originating user and the receiving user is enabled by the communication enabling unit and a call operation is performed on a call-in web page displayed by an originating terminal device of another originating user, transmits a call notification to the receiving terminal device notifying that a call request has been made, instead of transmitting a call instruction corresponding to the call operation.

In an aspect of the above-mentioned system, the call-in web page accepts an input of authentication information, the call instruction transmission unit, when communication between a first originating user and the receiving user is enabled by the communication enabling unit, transmits a call instruction including authentication information to the receiving terminal device when the authentication information is input and a call operation is performed on the call-in web page displayed by an originating terminal device of a second originating user, and the communication enabling unit, when an operation is performed by the receiving user on the receiving terminal device, which displays the authentication information and performs a call in accordance with the call instruction including the authentication information, enables communication for interaction among the first originating user using an originating terminal device of the first originating user, the second originating user using the originating terminal device of the second originating user, and the receiving user using the receiving terminal device.

In an aspect of the above-mentioned system, the call-in web page accepts an input of authentication information, and the communication enabling unit, when an input of authentication information and a call operation are performed on the call-in web page displayed by an originating terminal device of a second originating user while communication for interaction between a first originating user and the receiving user is enabled by the communication enabling means, enables communication for interaction among the first originating user using an originating terminal device of the first originating user, the second originating user using the originating terminal device of the second originating user, and the receiving user using the receiving terminal device.

In an aspect of the above-mentioned system, the authentication information is transmitted from the receiving terminal device to the originating terminal device of the first originating user through the communication for interaction enabled between the first originating user and the receiving user by the communication enabling unit.

In an aspect of the above-mentioned system, the web page transmission unit, in response to a request from the originating terminal device of the first originating user, transmits an authentication information notification web page, which notifies the authentication information to be input into the call-in web page, to the originating terminal device of the first originating user.

In an aspect of the above-mentioned system, the web page transmission unit, in response to a request from the originating terminal device of the first originating user, transmits an email address input web page, which accepts an input of an email address as a notification destination for the authentication information to be input into the call-in web page, to the originating terminal device of the first originating user, and the system further comprises an email transmission unit, which transmits an email notifying the authentication information to be input into the call-in web page to the email address input by the first originating user on the email address input web page displayed on the originating terminal device of the first originating user.

In an aspect of the above-mentioned system, the web page transmission unit transmits a call-in web page, including communication identification information for identifying the communication enabled by the communication enabling unit for interaction between a first originating user and the receiving user, to an originating terminal device of a second originating user in response to a request from the originating terminal device of the second originating user, and the communication enabling unit, when a call operation is performed on the call-in web page including the communication identification information displayed on the originating terminal device of the second originating user while communication for interaction between the first originating user and the receiving user is enabled by the communication enabling unit, enables communication for interaction among the first originating user using an originating terminal device of the first originating user, the second originating user using the originating terminal device of the second originating user, and the receiving user using the receiving terminal device.

In an aspect of the above-mentioned system, a URL of the call-in web page including the communication identification information is transmitted from the receiving terminal device to the originating terminal device of the first originating user via the communication for interaction between the first originating user and the receiving user enabled by the communication enabling unit.

In an aspect of the above-mentioned system, the web page transmission unit transmits a URL notification web page, which notifies the URL of the call-in web page including the communication identification information, to the originating terminal device of the first originating user in response to a request from the originating terminal device of the first originating user.

In an aspect of the above-mentioned system, the web page transmission unit transmits an email address input web page, which accepts an input of an email address as a notification destination for the URL of the call-in web page including the communication identification information, to the originating terminal device of the first originating user in response to a request from the originating terminal device of the first originating user, and the system further comprises an email transmission unit, that transmits an email notifying the URL of the call-in web page including the communication identification information to an email address input by the first originating user on the email address input web page displayed on the originating terminal device of the first originating user.

In an aspect of the above-mentioned system, the system is utilized by a plurality of receiving users, the web page transmission unit transmits the call-in web page including terminal identification information of a receiving terminal device of a receiving user who responded to a request from the originating terminal device, the system further comprises storage unit that stores, for each of the plurality of receiving terminal devices, a correspondence between terminal identification information of the receiving terminal device and an address of the receiving terminal device on the Internet, and the call instruction transmission unit transmits the call instruction to an address stored in the storage unit, corresponding to terminal identification information associated with the call-in web page for which a call operation is performed by the originating user.

In an aspect of the above-mentioned system, each of the plurality of receiving terminal devices includes a web browser function, the web page transmission unit transmits, in response to a request from a receiving terminal device of a first receiving user, the call-in web page, which accepts a call operation for a receiving terminal device used by a second receiving user, to the receiving terminal device of the first receiving user, the call instruction transmission unit, when a call operation for the second receiving user is performed on the call-in web page displayed on the receiving terminal device of the first receiving user while communication for interaction between the originating user and the first receiving user is enabled by the communication enabling unit, transmits a call instruction to the receiving terminal device of the second receiving user, and the communication enabling unit, when the second receiving user performs an operation to respond to a call performed by the receiving terminal device of the second receiving user in accordance with the call instruction, enables communication for interaction between the first receiving user using the receiving terminal device of the first receiving user and the second receiving user using the receiving terminal device of the second receiving user.

In an aspect of the above-mentioned system, the communication enabling unit, when a three-party interaction permission notification notifying permission for a three-party interaction is transmitted from the receiving terminal device of the first receiving user or the receiving terminal device of the second receiving user in the communication for interaction between the first receiving user and the second receiving user enabled by the communication enabling unit, enables communication for interaction among the originating user using the originating terminal device, the first receiving user using the receiving terminal device of the first receiving user, and the second receiving user using the receiving terminal device of the second receiving user.

In an aspect of the above-mentioned system, each of the plurality of receiving terminal devices includes a web browser function, the call instruction transmission unit, when a call operation is performed on the call-in web page of a second receiving user displayed on the originating terminal device while communication for interaction between the originating user and a first receiving user is enabled by the communication enabling unit, transmits a call instruction to a receiving terminal device of the second receiving user, and the communication enabling unit, when the second receiving user performs an operation to respond to a call performed by the receiving terminal device of the second receiving user in accordance with the call instruction, enables communication for interaction between the originating user using the originating terminal device and the second receiving user using the receiving terminal device of the second receiving user.

In an aspect of the above-mentioned system, the communication enabling unit, when a three-party interaction permission notification notifying permission for a three-party interaction is transmitted from the origination terminal device or the receiving terminal device of the second receiving user in the communication for interaction between the originating user and the second receiving user enabled by the communication enabling unit, enables communication for interaction among the originating user using the originating terminal device, the first receiving user using the receiving terminal device of the first receiving user, and the second receiving user using the receiving terminal device of the second receiving user.

In an aspect of the above-mentioned system, the web page transmission unit transmits a reservation acceptance web page, which accepts a reservation for a time slot during which the receiving user is available to provide a service, to the originating terminal device in response to a request from the originating terminal device, the web page transmission unit, when a reservation is performed by the originating user on the reservation acceptance web page displayed on the originating terminal device, transmits a reservation identification information notification web page, which notifies reservation identification information identifying the reservation, to the originating terminal device, the call-in web page accepts an input of reservation identification information, and the communication enabling unit, when reservation identification information corresponding to a current time and a call operation are performed on the call-in web page displayed on the originating terminal device, enables communication for interaction between the originating user using the originating terminal device and the receiving user using the receiving terminal device.

In an aspect of the above-mentioned system, the web page transmission unit transmits a reservation acceptance web page, which accepts a reservation for a time slot during which the receiving user is available to provide a service and an input of an email address as a notification destination for reservation identification information identifying the reservation, to the originating terminal device in response to a request from the originating terminal device, the system further comprises an email transmission unit, when a reservation and an input of an email address are performed by the originating user on the reservation acceptance web page displayed on the originating terminal device, transmits an email, which notifies reservation identification information identifying the reservation, to an email address input on the reservation acceptance web page, the call-in web page accepts an input of reservation identification information, and the communication enabling unit, when reservation identification information corresponding to a current time and a call operation are performed on the call-in web page displayed on the originating terminal device, enables communication for interaction between the originating user using the originating terminal device and the receiving user using the receiving terminal device.

In an aspect of the above-mentioned system, the web page transmission unit transmits a reservation acceptance web page, which accepts a reservation for a time slot during which the receiving user is available to provide a service, to the originating terminal device in response to a request from the originating terminal device, the web page transmission unit, when a reservation is performed by the originating user on the reservation acceptance web page displayed on the originating terminal device, transmits a URL notification web page notifying a URL of the call-in web page including reservation identification information identifying the reservation, to the originating terminal device, and the communication enabling unit, when a call operation is performed on the call-in web page including reservation identification information corresponding to a current time displayed on the originating terminal device, enables communication for interaction between the originating user using the originating terminal device and the receiving user using the receiving terminal device.

In an aspect of the above-mentioned system, the web page transmission unit transmits a reservation acceptance web page, which accepts a reservation for a time slot during which the receiving user is available to provide a service, to the originating terminal device in response to a request from the originating terminal device, the system further comprises an email transmission unit that transmits, when a reservation and an input of an email address have been performed by the originating user on the reservation acceptance web page displayed on the originating terminal device, transmits an email notifying a URL of the call-in web page including reservation identification information identifying the reservation to the email address, and the communication enabling unit, when a call operation is performed on the call-in web page including reservation identification information corresponding to a current time displayed on the originating terminal device, enables communication for interaction between the originating user using the originating terminal device and the receiving user using the receiving terminal device.

In an aspect of the above-mentioned system, the system further comprises a timing unit that measures a duration of time during of provision of a service from the receiving user to the originating user via the communication enabled by the communication enabling unit, and the communication enabling unit, when the time measured by the timing unit reaches a predetermined time, disables the communication that is currently enabled.

In an aspect of the above-mentioned system, the web page transmission unit transmits a remaining time notification web page notifying a remaining time obtained by subtracting the time measured by the timing unit from the predetermined time, to the originating terminal device, during a period in which the receiving user provides a service to the originating user via the communication enabled by the communication enabling unit.

In an aspect of the above-mentioned system, the receiving user provides call-in web pages corresponding to each of different types of services, the web page transmission unit transmits, a call-in web page corresponding to a request from the originating terminal device, from among the call-in web pages corresponding to the different types of services provided by the receiving user, to the originating terminal device, and the call instruction transmission unit, when a call operation is performed by the originating user on the call-in web page displayed on the originating terminal device, transmits a call instruction including service identification information identifying a type of service corresponding to the call-in web page, to the receiving terminal device.

In an aspect of the above-mentioned system, the call instruction transmission unit, when a call operation is performed on the call-in web page displayed on the originating terminal device of an originating user while communication for interaction between another originating user and the receiving user is enabled by the communication enabling unit, transmits a call notification notifying the service identification information associated with the call-in web page and that a call request has been made, to the receiving terminal device, instead of transmitting a call instruction corresponding to the call operation.

In an aspect of the above-mentioned system, the system further comprises a storage unit that stores addresses on the Internet of originating terminal devices of originating users prohibited from interacting with the receiving user, and the web page transmission unit does not transmit the call-in web page to any originating terminal device whose address is stored in the storage unit.

In an aspect of the above-mentioned system, the system further comprises a storage unit that stores addresses on the Internet of originating terminal devices of originating users prohibited from interacting with the receiving user, and the call instruction transmission unit, when a call operation is performed on the call-in web page displayed on an originating terminal device whose address is stored in the storage unit, does not transmit a call instruction for the receiving user to the receiving terminal device.

In an aspect of the above-mentioned system, the system further comprises the receiving terminal device, and the receiving terminal device performs imaging using an in-camera arranged on a surface side of a display of the receiving terminal device when the display is oriented such that a longitudinal direction of the display aligns with a vertical direction, and performs imaging using an out-camera arranged on a rear side of the display when the display is oriented such that a longitudinal direction of the display aligns with a horizontal direction, during a period in which communication for interaction between any originating user and the receiving user is enabled by the communication enabling unit.

### EFFECTS OF THE INVENTION

According to the present invention, the originating user (e.g., the service recipient) can engage in dialogue with the receiving user (e.g., the service provider) without requiring prior preparation by simply performing a call operation on a call initiation web page displayed in the web browser of their terminal device. Additionally, according to the present invention, the receiving user can engage in dialogue with the originating user without requiring prior preparation by simply performing an operation to respond to the call on their terminal device.

### BRIEF DESCRIPTION OF THE DRAWINGS

FIG. 1 is a diagram illustrating an overall configuration of a system according to an embodiment of the present invention.

FIG. 2 is a diagram illustrating a functional configuration of a server device according to the embodiment of the present invention.

FIG. 3 is a diagram illustrating an example of a screen displayed by an originating terminal device according to the embodiment of the present invention.

FIG. 4 is a diagram illustrating a configuration of a receiving terminal information table stored by a server device according to the embodiment of the present invention.

FIG. 5 is a diagram illustrating a state in which a receiving terminal device is making a call to a receiving user according to the embodiment of the present invention.

FIG. 6A is a diagram illustrating the originating terminal device in a state where communication between the originating terminal device and the receiving terminal device has been established according to the embodiment of the present invention.

FIG. 6B is a diagram illustrating the receiving terminal device in a state where communication between the originating terminal device and the receiving terminal device has been established according to the embodiment of the present invention.

FIG. 7 is a diagram illustrating a functional configuration of the receiving terminal device according to the embodiment of the present invention.

FIG. 8A is a diagram illustrating an example of a screen displayed by the originating terminal device when payment is made according to the embodiment of the present invention.

FIG. 8B is a diagram illustrating an example of a screen displayed by the originating terminal device when payment is made according to the embodiment of the present invention.

FIG. 8C is a diagram illustrating an example of a screen displayed by the originating terminal device when payment is made according to the embodiment of the present invention.

FIG. 8D is a diagram illustrating an example of a screen displayed by the originating terminal device when payment is made according to the embodiment of the present invention.

FIG. 8E is a diagram illustrating an example of a screen displayed by the originating terminal device when payment is made according to the embodiment of the present invention.

FIG. 9 is a diagram illustrating an example of a screen displayed by the receiving terminal device upon completion of payment according to the embodiment of the present invention.

FIG. 10A is a diagram illustrating an example of a screen displayed by the originating terminal device according to a modified example of the embodiment of the present invention.

FIG. 10B is a diagram illustrating an example of a screen displayed by the originating terminal device according to a modified example of the embodiment of the present invention.

FIG. 11 is a diagram illustrating an example of a screen displayed by the originating terminal device according to a modified example of the embodiment of the present invention.

FIG. 12 is a diagram illustrating an overall configuration of the system according to the modified example of the embodiment of the present invention.

FIG. 13A is a diagram illustrating a configuration of the receiving terminal information table stored by the server device according to the modified example of the embodiment of the present invention.

FIG. 13B is a diagram illustrating a configuration of the receiving terminal information table stored by the server device according to the modified example of the embodiment of the present invention.

FIG. 14 is a diagram illustrating a configuration of the receiving terminal information table stored by the server device according to the modified example of the embodiment of the present invention.

### DETAILED DESCRIPTION

### Embodiment

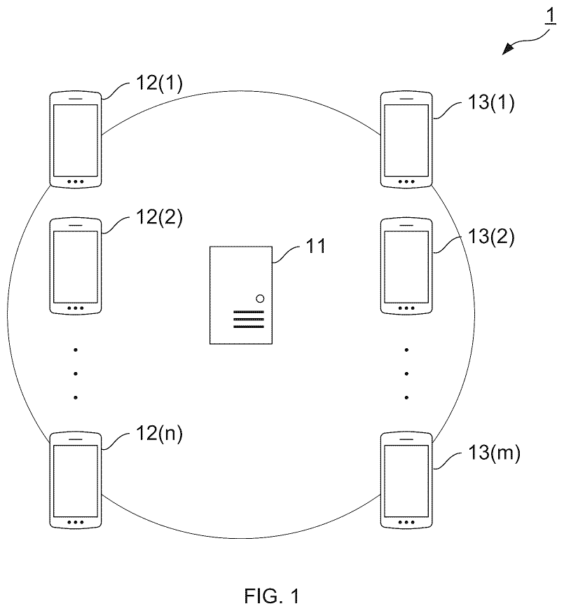

The following describes System 1 according to an embodiment of the present invention. FIG. 1 illustrates an overall configuration of system 1. System 1 comprises a server device 11, n number of originating terminal devices 12 (where n is any natural number), and m number of receiving terminal devices 13 (where m is any natural number). Each of originating terminal devices 12 is distinguished as originating terminal device 12(1), originating terminal device 12(2), . . . , originating terminal device 12(n). Similarly, each of receiving terminal devices 13 is distinguished as receiving terminal device 13(1), receiving terminal device 13(2), . . . , receiving terminal device 13(m). Each originating terminal device 12 and receiving terminal device 13 is connected to the Internet 9 via wired or wireless connections.

Originating terminal device 12 is a terminal device used by an originating user (e.g., a service recipient). The number of originating terminal devices 12 varies depending on a number of originating users of system 1. The originating user is an unspecified user who has not performed any user registration or similar tasks for system 1.

Originating terminal device 12 is a general terminal device equipped with a web browser function. Originating terminal device 12 is a computer equipped with the following hardware components:
a memory for storing various types of data,
a processor for performing various data processing tasks according to programs stored in the memory (non-volatile memory),
a communication interface for transmitting and receiving various types of data with external devices,
a display for presenting various types of information,
an input device, such as a touch panel, for accepting user operations,
a microphone for capturing user audio, such as voice,
a speaker for outputting sounds such as a ringtone or a voice of a conversation partner,
a camera for capturing images of the user's face and other visuals, and
a vibrator for vibrating originating terminal device 12 itself.

The display, input device, microphone, speaker, and camera, which are part of the hardware of the computer constituting originating terminal device 12, may be built into the main body of the computer or may be external devices connected to the main body of the computer. Additionally, the computer that constitutes the hardware of originating terminal device 12 can take various forms, such as a smartphone, tablet computer, laptop, or desktop computer.

Receiving terminal device 13 is a terminal device used by a receiving user (e.g., a service provider). The number of receiving terminal devices 13 varies depending on a number of receiving users of system 1. The receiving user is a user who possesses a unique web page sent from server device 11 to any originating terminal device 12. A URL of the receiving user's web page is stored in server device 11 in association with terminal identification information that identifies receiving terminal device 13 and an address of receiving terminal device 13 on the Internet 9.

Receiving terminal device 13 is a general terminal device equipped with a telephone function, in which a program (app) related to this embodiment is installed. Hardware of receiving terminal device 13 is the same as that of originating terminal device 12.

Server device 11 is a device that enables communication between originating terminal device 12 and receiving terminal device 13, allowing users to engage in interaction. Here, server device 11 is assumed to be a single computer, but it may also be configured by multiple computers connected via a network and operating in coordination.

Hardware of server device 11 is a computer equipped with the following components:
a memory for storing various types of data,
a processor that performs various data processing tasks according to programs stored in the memory (non-volatile memory), and
a communication interface for transmitting and receiving various types of data with external devices.

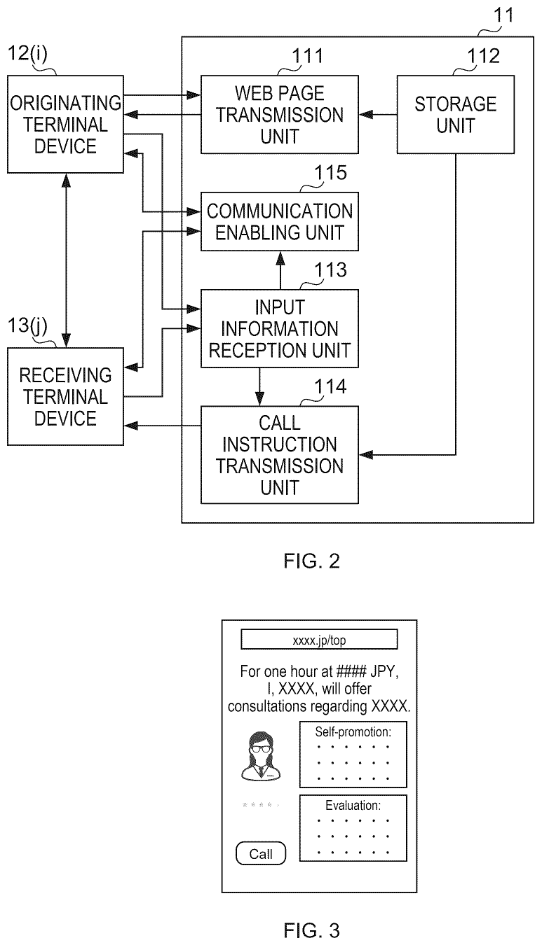

FIG. 2 is a diagram illustrating a functional configuration of server device 11. In other words, when the processor of the computer, which constitutes the hardware of server device 11, performs data processing according to a program related to the present embodiment, it functions as a device equipped with the components shown in FIG. 2. The functional configuration of server device 11 is explained below.

Web page transmission unit 111, in response to a request from any originating terminal device 12, transmits a requested call-in web page for the receiving user to requesting originating terminal device 12.

FIG. 3 is a diagram illustrating an example of a call-in web page. A call-in web page is a web page designed to accept operations for initiating a call to a specific receiving terminal device 13. When any originating user enters into the web browser of his/her originating terminal device 12 a URL corresponding to a receiving user he/she wishes to interact with, a call-in web page like the one shown in FIG. 3 is displayed. The call-in web page displays information about fees for services provided by the receiving user to the originating user, a photograph of the receiving user, a self-introduction by the receiving user, and information about evaluations of the receiving user posted by originating users who have used his/her services in the past. The call-in web page also displays a “Call” button. This “Call” button is used to initiate a call to receiving terminal device 13 associated with the call-in web page.

Referring to FIG. 2, the explanation of the functional configuration of server device 11 continues. Storage unit 112 stores various types of data. The data stored in storage unit 112 includes call-in web pages that web page transmission unit 111 sends to any originating terminal device 12. More specifically, this includes various types of data necessary for displaying the call-in web pages, such as text data written in languages such as HTML or Java (Java is a registered trademark), scripts, and content data such as images.

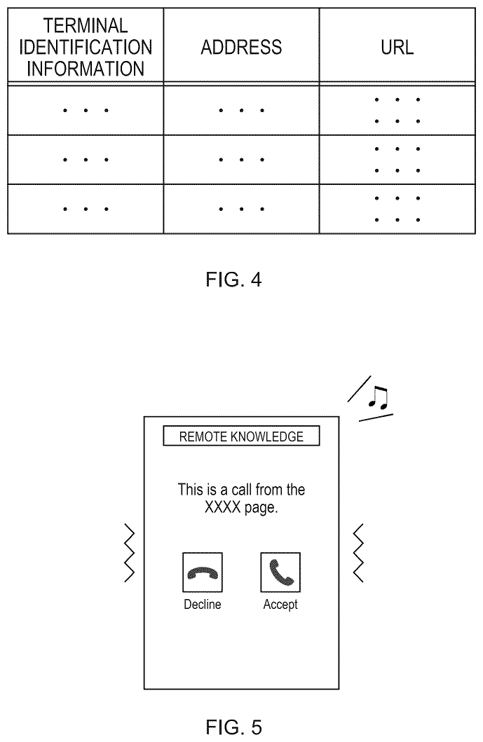

Additionally, storage unit 112 stores a table with the configuration shown in FIG. 4 (hereinafter referred to as the “receiving terminal information table”). The receiving terminal information table stores, for each receiving terminal device 13, terminal identification information that identifies receiving terminal device 13, an address of receiving terminal device 13 on the Internet 9, and the URL of a call-in web page used to call receiving terminal device 13, all in corresponding associations. If a single receiving user can provide multiple different services, that receiving user can have a separate call-in web page corresponding to each of those different services. Therefore, the “URL” field in each data record of the receiving terminal information table may store multiple URLs.

Referring to FIG. 2, the explanation of the functional configuration of server device 11 continues. Input information reception unit 113 receives information sent from originating terminal device 12 to server device 11 when an originating user performs an operation, such as a touch action, on the “Call” button displayed on the call-in web page (FIG. 3).

Call instruction transmission unit 114, upon receiving information from input information reception unit 113 indicating that an operation has been performed on the “Call” button by originating terminal device 12, identifies the Internet 9 address of receiving terminal device 13 corresponding to the call-in web page containing the “Call” button from the receiving terminal information table (FIG. 4). It then sends a call instruction to the identified address.

Receiving terminal device 13, upon receiving the call instruction sent by call instruction transmission unit 114, initiates a call to the receiving user in the same manner as that used in the calling method used in telephony functions. The calling method used in telephony functions refers to a manner in which a specific sound or music is played continuously or intermittently, a specific vibration pattern is performed continuously or intermittently by receiving terminal device 13, or a combination of these methods.

FIG. 5 illustrates receiving terminal device 13 in a state where it is calling the receiving user. When receiving terminal device 13 calls the receiving user, it continuously emits a ringtone and vibrates, for example, to attract attention of the receiving user who may not be paying attention to receiving terminal device 13. Additionally, when receiving terminal device 13 notifies the call to the receiving user, it displays a “Reject” button, an “Answer” button, and text indicating which call-in web page the call originates from on its display.

When the receiving user notices the call, he/she checks which call-in web page the call originates from by reading the text displayed on the screen. If he/she wishes to start an interaction with the originating user, he/she performs an operation, such as a touch action, on the “Answer” button (an operation to accept the call). In response to this operation, the receiving user can begin an interaction with the originating user who initiated the call, using receiving terminal device 13 (details to be described later). On the other hand, if the receiving user does not wish to start an interaction with the originating user, he/she can perform an operation, such as a touch action, on the “Reject” button. If this operation is performed, no interaction will take place between the receiving user and the originating user who initiated the call.

Referring to FIG. 2, the explanation of the functional configuration of server device 11 continues. If the receiving user performs an operation on the “Answer” button on receiving terminal device 13 (FIG. 5) that is calling in response to the call instruction sent by call instruction transmission unit 114, input information reception unit 113 receives information from receiving terminal device 13 indicating that the “Answer” button operation was performed.

Communication enabling unit 115, upon input information reception unit 113 receiving information indicating that the “Answer” button operation has been performed, enables communication for interaction between the originating user using originating terminal device 12 (the source of the information indicating that the “Call” button operation was performed) and the receiving user using receiving terminal device 13 (the source of the information indicating that the “Answer” button operation was performed).

The communication enabled by communication enabling unit 115 refers to real-time mutual transmission and reception of at least one of audio data, text data, or video data between originating terminal device 12 and receiving terminal device 13. Furthermore, the interaction between the originating user using originating terminal device 12 and the receiving user using receiving terminal device 13 refers to the real-time mutual exchange of at least one of speaking and listening to audio, entering and reading text, or performing and observing gestures (such as sign language).

The communication enabled by communication enabling unit 115, where originating terminal device 12 and receiving terminal device 13 mutually transmit and receive at least one of audio data, text data, or video data in real time, may occur either through server device 11 or without involving server device 11. The above constitutes the explanation of the functional configuration of server device 11.

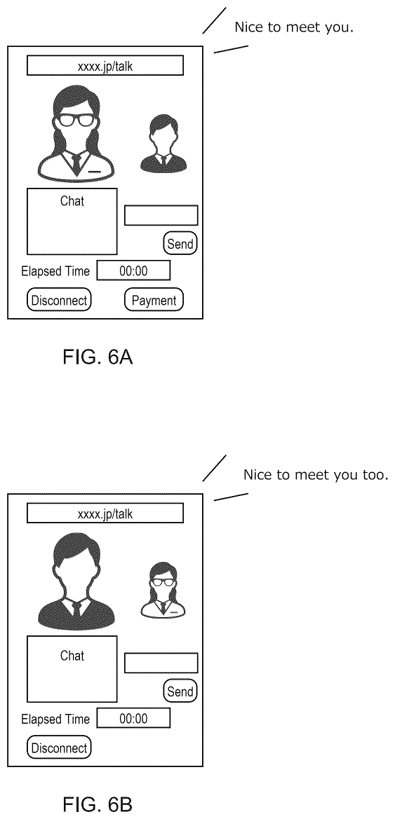

FIG. 6A illustrates originating terminal device 12 in a state where communication between originating terminal device 12 and receiving terminal device 13 has been enabled by communication enabling unit 115. FIG. 6B illustrates receiving terminal device 13 in a state where communication between originating terminal device 12 and receiving terminal device 13 has been enabled by communication enabling unit 115.

On the display of originating terminal device 12 shown in FIG. 6A, the following are displayed:
a video showing the receiving user (the interaction partner),
a video showing the originating user's own image,
a history of text chat,
an input field for writing new text in the text chat,
the elapsed time since the start of the service provided by the receiving user to the originating user,
a “Disconnect” button to terminate communication with receiving terminal device 13, and
a “Pay” button (details to be discussed later) for paying a fee for the service provided by the receiving user to the originating user.

The speaker of originating terminal device 12 emits voices of the receiving user, i.e. the interaction partner. The camera of originating terminal device 12 continuously captures images of the originating user. The microphone of originating terminal device 12 continuously captures voices of the originating user. Originating terminal device 12 sequentially transmits video data, representing the images of the originating user captured by the camera, and audio data, representing the originating user's voices captured by the microphone, to receiving terminal device 13.

On the display of receiving terminal device 13 shown in FIG. 6B, the following are displayed:
a video showing the originating user (the interaction partner),
a video showing the receiving user's own image,
a history of text chat,
an input field for writing new text in the text chat,
the elapsed time since the start of the service provided by the receiving user to the originating user, and
a “Disconnect” button to terminate communication with originating terminal device 12.

The speaker of receiving terminal device 13 emits voices of the originating user, i.e. the interaction partner. The camera of receiving terminal device 13 continuously captures images of the receiving user. The microphone of receiving terminal device 13 continuously captures voices of the receiving user. Receiving terminal device 13 sequentially transmits video data, representing the images of the receiving user captured by the camera, and audio data, representing the receiving user's voices captured by the microphone, to originating terminal device 12.

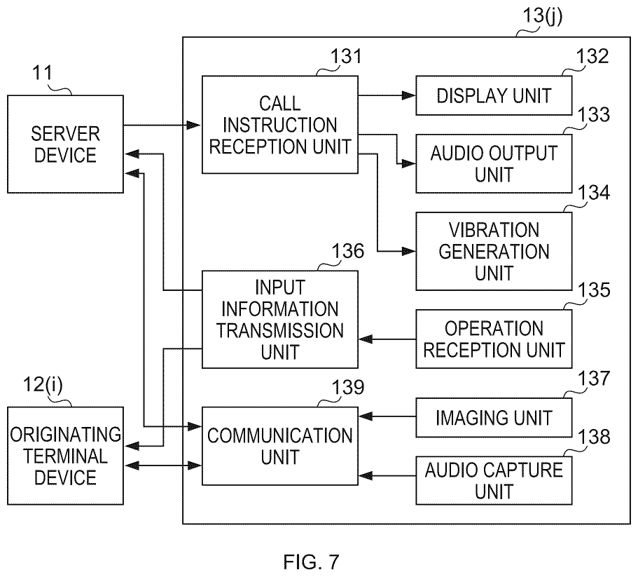

FIG. 7 illustrates a functional configuration of receiving terminal device 13. In other words, when the processor of the computer, which constitutes the hardware of receiving terminal device 13, performs data processing according to the program (app) related to the present embodiment, it functions as a device equipped with the components shown in FIG. 7. The functional configuration of receiving terminal device 13 is explained below.

Call instruction reception unit 131 receives call instructions sent from server device 11. The call instructions received by call instruction reception unit 131 include information (e.g., a URL) indicating from which of the one or more call-in web pages associated with the receiving user using receiving terminal device 13 the call originated.

Display unit 132 displays various types of information, such as a video showing an appearance of the interaction partner. Audio output unit 133 emits sounds such as ringtones and voices of the interaction partner. Vibration generation unit 134 vibrates the device during a call.

Operation reception unit 135 accepts various operations, such as touch actions, performed by the receiving user. Input information transmission unit 136 transmits information entered by the receiving user via operations received by operation reception unit 135 to server device 11 or originating terminal device 12.

Imaging unit 137 captures the receiving user and generates video data representing the recorded video. Audio capture unit 138 captures the receiving user's voices and generates audio data representing the recorded sound. Communication unit 139 communicates with server device 11 to establish a connection with originating terminal device 12. Once the connection with originating terminal device 12 is established, communication unit 139 sequentially transmits the video data generated by imaging unit 137 and the audio data generated by audio capture unit 138 to originating terminal device 12. Simultaneously, it receives video data representing the image of the originating user and audio data representing the voice of the originating user, which are sequentially sent from originating terminal device 12.

The computer that constitutes the hardware of originating terminal device 12 functions as a device equipped with components similar to those of receiving terminal device 13 (FIG. 7). It achieves this by executing processes corresponding to the code (written in languages such as HTML or Java (registered trademark) scripts) included in web pages, such as the call-in web pages, transmitted from server device 11 in accordance with the web browser program.

When the receiving user provides a paid service to the originating user, the originating user can make the payment by operating originating terminal device 12. Additionally, the receiving user can confirm the completion of the payment using receiving terminal device 13.

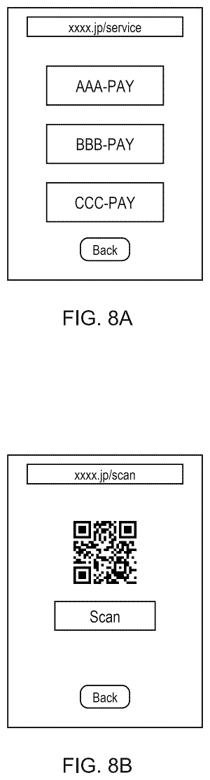

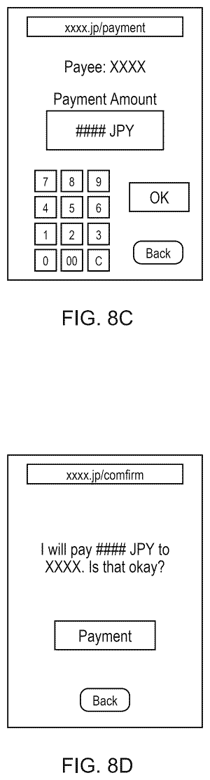

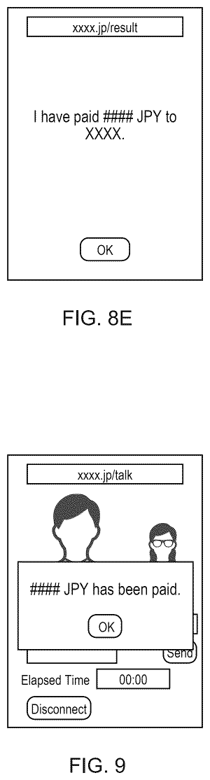

FIGS. 8A through 8E illustrate screens displayed on originating terminal device 12 when the originating user makes a payment. The screens shown in FIGS. 8A through 8E are web pages transmitted from web page transmission unit 111 of server device 11 to originating terminal device 12. When the originating user performs an operation, such as a touch action, on the “Pay” button displayed on the screen shown in FIG. 6A, the screen shown in FIG. 8A appears. On the screen in FIG. 8A, the payment systems available to the originating user are listed as selectable options. The payment systems listed on this screen are, for example, those for which an app (program) for the payment system is installed on originating terminal device 12.

When the originating user performs an operation, such as a touch action, on the button corresponding to a payment system on the screen shown in FIG. 8A, the screen shown in FIG. 8B is displayed on originating terminal device 12. On the screen shown in FIG. 8B, a barcode (e.g., a QR code or another form of two-dimensional barcode, which is an example of payment information) is displayed for making a payment to the receiving user's account using the payment system selected by the originating user.

When the originating user performs an operation, such as a touch action, on the “Scan” button on the screen shown in FIG. 8B, the screen shown in FIG. 8C is displayed on the originating terminal device 12. The screen shown in FIG. 8C displays the name of the payee, a field for entering the payment amount, and a virtual keyboard. The name of the payee displayed on the screen in FIG. 8C is part of the information obtained by decoding the barcode displayed on the screen in FIG. 8B. The originating user, after verifying the payee's name on the screen in FIG. 8C, enters the payment amount and performs an operation, such as a touch action, on the “OK” button. The payment amount corresponds to the amount specified on the call-in web page (FIG. 3). If the payment amount is unclear, the originating user can confirm the amount by engaging in a voice interaction with the receiving user while the screen shown in FIG. 8C is displayed.

When the originating user performs an operation, such as a touch action, on the “OK” button on the screen shown in FIG. 8C, the screen shown in FIG. 8D is displayed on originating terminal device 12. The screen shown in FIG. 8D is a confirmation screen asking the originating user to verify the payee and the payment amount. When the originating user performs an operation, such as a touch action, on the “Pay” button on the screen shown in FIG. 8D, the screen shown in FIG. 8E is displayed on originating terminal device 12. The screen shown in FIG. 8E indicates that the payment has been successfully completed.

FIG. 9 illustrates the screen displayed on receiving terminal device 13 when the payment from the originating user to the receiving user is successfully completed. When the screen shown in FIG. 8E is displayed on originating terminal device 12, payment completion information, including the payment amount and a notification that the payment has been completed, is sent from originating terminal device 12 to receiving terminal device 13. When receiving terminal device 13 receives the payment completion information from originating terminal device 12, it displays a popup message, such as “####JPY has been paid,” as shown in FIG. 9. This allows the receiving user to know that the payment process for the service provided to the originating user has been completed.

Once the payment has been completed as described above, and the originating user performs an operation, such as a touch action, on the “OK” button on the screen shown in FIG. 8E, originating terminal device 12 returns to displaying the interaction screen, i.e., the screen shown in FIG. 6A. Once the payment has been completed as described above, and the receiving user performs an operation, such as a touch action, on the “OK” button on the screen shown in FIG. 9, receiving terminal device 13 closes the popup message and returns to displaying the interaction screen, i.e., the screen shown in FIG. 6B.

Subsequently, in the “Elapsed Time” section of the interaction screens on both originating terminal device 12 and receiving terminal device 13, the elapsed time since the completion of the payment process is displayed. For example, if the fee for the service provided by the receiving user to the originating user is 1,000 JPY per hour, and the originating user has paid 1,000 JPY for one hour, both the originating user and the receiving user can use the time displayed in the “Elapsed Time” section to track the remaining time for their one-hour interaction.

When the scheduled interaction time has elapsed and there is no remaining time, the receiving user can end the interaction with the originating user by performing an operation, such as a touch action, on the “Disconnect” button on the screen shown in FIG. 6B. The originating user can also end the interaction with the receiving user by performing an operation, such as a touch action, on the “Disconnect” button on the screen shown in FIG. 6A.

According to the above-described system 1, the originating user can easily interact with the desired receiving user by simply opening the receiving user's call-in web page in a web browser and performing an operation on the “Call” button, without the need for prior user registration or other preparatory tasks. Furthermore, according to the above-described system 1, the receiving user can interact with the originating user simply by performing an operation on the “Answer” button displayed on receiving terminal device 13 in response to a call initiated using the same calling method as that used in telephony, such as emitting a ringtone.

### Modified Examples

The described embodiment is merely one example of the present invention, and various modifications may be made within the scope of the technical concept of the invention. The following are examples of such modifications. Note that two or more of the modified examples described below may be combined as appropriate.

(1) In the above-described embodiment, payment information is sent from receiving terminal device 13 to originating terminal device 12, and originating terminal device 12 uses this payment information to perform the payment processing. Alternatively, originating terminal device 12 may send the payment information to receiving terminal device 13, and receiving terminal device 13 may use this payment information to perform the payment processing.

That is, in system 1, the payment information for the fees related to services provided by the receiving user to the originating user, or services requested by the originating user from the receiving user, may be transmitted to receiving terminal device 13 through the communication enabled by communication enabling unit 115.

In this modified example, originating terminal device 12 transmits payment information to receiving terminal device 13, which includes information identifying the account of the payment system used by the originating user. Receiving terminal device 13 sends a request to the payment system used by the receiving user to transfer the amount entered by the receiving user on receiving terminal device 13 from the originating user's account (as indicated by the payment information received from originating terminal device 12) to the receiving user's account within the same payment system. In response to the request, once the payment system completes the transaction, a payment completion notification is sent from the payment system to originating terminal device 12, allowing the originating user to confirm the amount paid.

(2) In the above-described embodiment, payment processing is performed after receiving terminal device 13 responds to the call and communication between originating terminal device 12 and receiving terminal device 13 is enabled. Alternatively, payment processing may be carried out before the call is initiated.

That is, in system 1, web page transmission unit 111 may be configured to send a payment web page to originating terminal device 12. This payment web page displays payment information for the fees related to services provided by the receiving user to the originating user, or services requested by the originating user from the receiving user, through the communication enabled by communication enabling unit 115. The system may include a payment completion information reception unit that receives payment completion information from originating terminal device 12, indicating that the payment has been completed using the payment information. In this configuration, call instruction transmission unit 114 sends a call instruction only when the payment completion information reception unit has received the payment completion information.

In this modified example, the account information of the payment system used by receiving terminal device 13 is pre-registered in server device 11. When the originating user performs a touch operation on the “Call” button on the call-in web page (FIG. 3), server device 11 sends a payment web page to originating terminal device 12. This web page displays payment information, including the account details of the receiving user. Originating terminal device 12 displays the payment web page received from server device 11.

When the originating user enters the service fee amount on the payment web page and performs an operation to initiate payment, originating terminal device 12 sends a payment request to the payment system used by the originating user. This request instructs the payment system to transfer the amount entered on the payment web page from the originating user's account to the receiving user's account as specified in the payment information. When originating terminal device 12 receives a payment completion notification from the payment system in response to its request, it uses this notification to generate payment completion information indicating that the payment has been completed. Originating terminal device 12 then sends the generated payment completion information to server device 11.

When server device 11 receives the payment completion information from originating terminal device 12, it uses call instruction transmission unit 114 to send a call instruction to receiving terminal device 13. In response to this call instruction, receiving terminal device 13 initiates the calling process for the receiving user, which includes displaying the call screen (FIG. 5) and emitting a ringtone.

Subsequently, when the receiving user responds to the call and the interaction between the originating user and the receiving user begins, both originating terminal device 12 and receiving terminal device 13 display the remaining time. This remaining time is calculated by subtracting the elapsed time from the time corresponding to the amount already paid by the originating user to the receiving user through the payment. When the remaining time reaches zero, the communication connection established between originating terminal device 12 and receiving terminal device 13 for the interaction is automatically terminated.

(3) In the above-described embodiment, it is assumed that the originating user directly requests payment processing from their payment system using originating terminal device 12. Alternatively, server device 11 may request the payment processing from the payment system on behalf of the originating user.

That is, in system 1, web page transmission unit 111 may send a payment information request web page that prompts the user to input payment information. System 1 may include a payment information reception unit to receive payment information from originating terminal device 12, and a payment unit to communicate with an external device responsible for payment processing. The payment unit performs the processing necessary for the payment of fees related to the services provided by the receiving user to the originating user, or services requested by the originating user from the receiving user, through the communication enabled by communication enabling unit 115. This configuration allows server device 11 to handle payment processing directly with the external payment system.

In this modified example, the account information of the payment system used by the receiving user is pre-registered in server device 11. For example, when the originating user performs a touch operation on the “Pay” button on the screen shown in FIG. 6A, server device 11 generates a payment information request web page prompting the user to input payment information and sends it to originating terminal device 12. Originating terminal device 12 displays the payment information request web page received from server device 11. On the payment information request web page, the originating user selects his/her payment system, enters the payment amount, and performs an operation to initiate the payment. In response to this operation, originating terminal device 12 sends payment information to server device 11. This payment information includes details of the payment system, information identifying the originating user's account in that payment system, and the payment amount.

Server device 11 uses the payment information received from originating terminal device 12 to send a payment processing request to an external device (e.g., the payment system used by the originating user). This request instructs the external device to transfer the payment amount specified by the originating user from the originating user's account to the receiving user's account in the payment system used by the receiving user. When server device 11 receives a notification from the external device confirming the completion of the requested payment processing, it sends a notification of payment completion to originating terminal device 12 and receiving terminal device 13. Originating terminal device 12 and receiving terminal device 13 display the notification, allowing the originating user and the receiving user to confirm that the payment of the service fee has been completed.

The payment processing described above may be performed before server device 11 initiates the call to receiving terminal device 13. In other words, this modified example can be combined with the previously described modified example (2).

In that case, call instruction transmission unit 114 sends the call instruction only after the payment unit completes the processing for the service fee payment with the external device.

In this modified example, server device 11 may include a timing unit to measure the service provision time. The payment unit can then perform the payment processing with the external device based on the fees corresponding to the service provision time measured by the timing unit.

In that case, server device 11 measures the elapsed time after the communication connection for the interaction between originating terminal device 12 and receiving terminal device 13 is established, considering it as the service provision time. After the communication connection for the interaction is terminated, server device 11 uses the payment information received from originating terminal device 12 to request the external device to process the payment of the service fee based on the measured elapsed time.

(4) If the receiving user has predetermined time periods during which they cannot provide services (hereinafter referred to as “service-off hours”), they can register these service-off hours in advance with server device 11. When server device 11 receives an access request from originating terminal device 12 for the receiving user during the service-off hours, it may notify originating terminal device 12 that the receiving user is currently unavailable to provide services.

In other words, in system 1, web page transmission unit 111 may be configured such that if it receives a request from originating terminal device 12 for the call-in web page (FIG. 3) during a designated time period, it sends a time-out notification web page to originating terminal device 12 instead of the call-in web page. This notification web page informs originating terminal device 12 that receiving terminal device 13 cannot be called during the specified time period.

In this modified example, if the originating user operates originating terminal device 12 to display the receiving user's call-in web page during a non-service time, an out-of-hours notification web page is displayed on originating terminal device 12. For instance, this page might display a message such as, “The service is currently unavailable. Service hours are weekdays from 9:00 AM to 6:00 PM.”

(5) The receiving user may not always be able to provide services, depending on their situation at any given time. Therefore, the receiving user can register status information with server device 11 indicating whether they are currently available to provide services. When the receiving user is unavailable, a notification indicating that the service cannot be provided by the receiving user may be sent to the originating user.

That is, system 1 may include a status information reception unit that receives status information from receiving terminal device 13, indicating whether the receiving user is available to provide services. In this system, web page transmission unit 111 may be configured to send an interaction-unavailable notification web page, instead of the call-in web page (FIG. 3), during the time the status information received by the status information reception unit indicates that the receiving user is unavailable to provide services. This web page notifies the originating user of the unavailability of the receiving user's service.

In this modified example, when the receiving user becomes unable to provide services, they operate receiving terminal device 13 to send status information indicating “service unavailable” to server device 11. Later, when the receiving user becomes able to provide services again, he/she operates receiving terminal device 13 to send status information indicating “service available” to server device 11.

After server device 11 receives status information indicating “service unavailable” from receiving terminal device 13, if it receives a request from originating terminal device 12 to send the receiving user's call-in web page before receiving status information indicating “service available,” it sends an interaction-unavailable notification web page to originating terminal device 12 instead of the call-in web page. For example, this web page may display a message such as, “Currently, the service is unavailable due to circumstances. Please try again later.” Originating terminal device 12 then displays the interaction-unavailable notification web page received from server device 11.

In this modified example, instead of receiving terminal device 13 sending status information indicating “service available” to server device 11 based on the receiving user's operation, receiving terminal device 13 may be configured to automatically send status information indicating “service available” to server device 11 after a predefined period of time has elapsed or after a time specified by the receiving user has passed, following the transmission of status information indicating “service unavailable.”

(6) When the receiving user is interacting with a first originating user, a second originating user may wish to interact with the receiving user. In such cases, server device 11 may send a notification to originating terminal device 12 of the second originating user, indicating that the receiving user is currently engaged in an interaction with another originating user.

In other words, in system 1, web page transmission unit 111 may be configured to send an interaction-in-progress notification web page to originating terminal device 12 used by another originating user, instead of the call-in web page (FIG. 3), if a request for the call-in web page is received from that device while communication enabling unit 115 has enabled communication for interaction between the receiving user and an originating user. This notification informs requesting originating terminal device 12 that the receiving user is currently interacting with another originating user.

In this modified example, if the second originating user operates his/her originating terminal device 12 to display the receiving user's call-in web page, an interaction-in-progress notification web page is displayed instead. For example, this page might display a message such as, “Currently, engaged in an interaction with another user. Please try again later.”

(7) In the modified example (6), the second originating user does not perform a call operation to the receiving user. Therefore, the receiving user cannot know that the second originating user wishes to interact with him/her. To enable the receiving user to be aware of the second originating user's intention to interact, server device 11 may send the call-in web page (FIG. 3) to originating terminal device 12 of the second originating user, even while the receiving user is interacting with the first originating user. If the second originating user performs a touch operation on the “Call” button of the call-in web page, server device 11 can notify receiving terminal device 13 of the request to call, instead of initiating an actual call.

In other words, in system 1, call instruction transmission unit 114 may be configured such that, if a call operation is performed on the call-in web page displayed by originating terminal device 12 of another originating user while communication enabling unit 115 has enabled communication for interaction between the receiving user and a current originating user, it sends a call notification to receiving terminal device 13. This call notification indicates that a request for a call was made, instead of sending a call instruction corresponding to the operation.

In this modified example, when the second originating user performs a touch operation on the “Call” button in the call-in web page, server device 11 sends a web page similar to the interaction-in-progress notification web page described in the modified example (6) to originating terminal device 12 of the second originating user. Consequently, originating terminal device 12 of the second originating user displays a message such as, “Currently, engaged in an interaction with another user. Please try again later.”

Additionally, when the second originating user performs a touch operation on the “Call” button in the call-in web page, server device 11 sends a call notification to receiving terminal device 13. Upon receiving this call notification, receiving terminal device 13 displays a message such as “You have an incoming call.” By viewing this message, the receiving user can become aware that another originating user attempted to initiate an interaction with him/her while he/she was engaged in a conversation with the first originating user.

(8) When the first originating user (hereinafter referred to as “originating user A”) and the receiving user are interacting using system 1, there may be instances where the second originating user (hereinafter referred to as “originating user B”) is to be included in the interaction.

To address the need described above, as a modified example, in system 1, the call-in web page (FIG. 3) accepts the input of authentication information. If originating terminal device 12 of the second originating user displays the call-in web page and enters authentication information followed by a call operation while communication for interaction between the first originating user and the receiving user is possible, call instruction transmission unit 114 sends a call instruction with authentication information to receiving terminal device 13. Upon receiving this, communication enabling unit 115 displays the authentication information on receiving terminal device 13. If the receiving user then performs an operation to respond to the call, communication between the first originating user (using his/her originating terminal device 12), the second originating user (using his/her originating terminal device 12), and the receiving user (using receiving terminal device 13) is enabled for interaction. This configuration allows the second originating user to join the ongoing conversation between the first originating user and the receiving user.

In this modified example, the call-in web page sent by server device 11 to originating terminal device 12 includes a text box that accepts the input of authentication information. Originating user A, for example, may be an acquaintance of originating user B and is provided with the authentication information by originating user B. This authentication information can be determined arbitrarily by originating user A.

Originating user A conveys the authentication information to the receiving user. Originating user B, using his/her originating terminal device 12 (hereinafter referred to as “originating terminal device 12B”), displays the call-in web page and enters the authentication information provided by originating user A into the web page. After entering the information, originating user B performs an operation on the “Call” button. In response to this action, server device 11 sends a call instruction, accompanied by the authentication information entered by originating user B, to receiving terminal device 13.

In response to the call instruction from server device 11, receiving terminal device 13 displays a screen (refer to FIG. 5) to call the receiving user. This screen includes the authentication information entered by originating user B. If the authentication information conveyed by originating user A matches the authentication information displayed on the screen of receiving terminal device 13, the receiving user will recognize that the originating user is originating user B. In this case, the receiving user will perform an operation on the “Answer” button to accept the call. In response to that operation, server device 11 enables communication between receiving terminal device 13, originating terminal device 12A, and originating terminal device 12B. As a result, an interaction becomes possible among the receiving user, originating user A, and originating user B, allowing for a three-way conversation.

Instead of the modified example described above, a configuration may be adopted where the call-in web page accepts the input of authentication information, and communication enabling unit 115, while communication for interaction between the first originating user and the receiving user is enabled, and allows the second originating user to perform an operation on the call-in web page (FIG. 3) displayed on his/her originating terminal device 12. This operation includes entering the pre-set authentication information and initiating the call. Upon completion of this operation, communication is enabled for interaction among the first originating user (using his/her originating terminal device 12), the second originating user (using his/her originating terminal device 12), and the receiving user (using receiving terminal device 13).

In this modified example, prior to originating user B's participation in the interaction, server device 11 stores the authentication information in association with the communication between originating terminal device 12A and receiving terminal device 13. This authentication information may be determined by the receiving user and registered with server device 11 using receiving terminal device 13, or it may be decided by originating user A and registered with server device 11 using originating terminal device 12A. Additionally, the authentication information may be determined by server device 11 and notified to the originating user through originating terminal device 12A, or it may be decided by server device 11 and notified to the receiving user through receiving terminal device 13. Originating user B enters the authentication information provided by originating user A in the call-in web page and performs an operation on the “Call” button.

If the authentication information entered by originating user B matches the authentication information stored by server device 11, server device 11 sends a call instruction to receiving terminal device 13. In this case, the authentication information may be displayed on the screen (refer to FIG. 5) where receiving terminal device 13 is calling the receiving user. When the receiving user performs an operation on the “Answer” button on the screen, server device 11 enables communication between receiving terminal device 13, originating terminal device 12A, and originating terminal device 12B. As a result, communication becomes possible among the receiving user, originating user A, and originating user B, enabling a three-way conversation.

In either of the two modified examples above, it is possible to adopt a configuration where, through the communication enabled by communication enabling unit 115 for the interaction between the first originating user and the receiving user, receiving terminal device 13 sends the authentication information to originating terminal device 12 of the first originating user.

In this case, the receiving user can notify originating user A, with whom he/she is interacting, of the authentication information he/she has determined, or the authentication information determined by server device 11 or receiving terminal device 13, which is displayed on receiving terminal device 13.

Additionally, in either of the two modified examples above, web page transmission unit 111 may be configured to send an authentication information notification web page to originating terminal device 12 of the first originating user in response to a request from originating terminal device 12 of the first originating user. This web page would notify the authentication information to be entered on the call-in web page.

In this case, originating user A can view the authentication information notification web page displayed on originating terminal device 12A and obtain the authentication information.

Additionally, in either of the two modified examples above, web page transmission unit 111 may be configured to send an email address input web page to originating terminal device 12 of the first originating user in response to a request from originating terminal device 12 of the first originating user. This web page would allow the first originating user to input the email address where the authentication information should be notified. After the first originating user enters the email address on the email address input web page displayed on his/her originating terminal device 12, an email transmission unit would send an email containing the authentication information to the email address entered by the first originating user.

In this case, originating user A can notify originating user B of the authentication information by entering originating user B's email address into the email address input web page. This way, originating user A can send the authentication information to originating user B via email.

Instead of the two modified examples described above, in system 1, web page transmission unit 111 may be configured to send a call-in web page with communication identification information, which identifies the communication possible between the first originating user and the receiving user, to originating terminal device 12 of the second originating user in response to a request from originating terminal device 12 of the second originating user. If, during the time when communication between the first originating user and the receiving user is enabled by communication enabling unit 115, the second originating user performs a call operation on the call-in web page displayed on originating terminal device 12 of the second originating user, communication enabling unit 115 would enable communication for interaction among the first originating user (using his/her originating terminal device 12), the second originating user (using his/her originating terminal device 12), and the receiving user (using receiving terminal device 13). This configuration allows the second originating user to join the ongoing conversation between the first originating user and the receiving user.

In this modified example, for instance, in response to a request from originating user A, server device 11 generates a dedicated call-in web page for originating user B to participate in the conversation. The URL of this dedicated call-in web page is then notified to originating user A. Originating user A informs originating user B of the notified URL. When originating user B enters the URL provided by originating user A into the browser of originating terminal device 12B, a call-in web page with communication identification information, which identifies the communication used for the interaction between the receiving user and originating user A, is sent to originating terminal device 12B. When originating user B performs an operation on the “Call” button on the call-in web page, server device 11 connects originating terminal device 12B to the communication identified by the communication identification information associated with that call-in web page. This enables a three-way interaction among the receiving user, originating user A, and originating user B.

In system 1 related to the above modified example, a configuration may be adopted where, through the communication enabled by communication enabling unit 115 for interaction between the first originating user and the receiving user, a call-in web page URL with communication identification information is sent from receiving terminal device 13 to originating terminal device 12 of the first originating user.

In this case, the URL of the dedicated call-in web page for originating user B to join the conversation is notified to the receiving user by receiving terminal device 13. Then, the receiving user informs originating user A of this URL within the context of their interaction using system 1. Then, originating user A can inform originating user B of the URL, for example, through a phone call or email. This allows originating user B to join the conversation between the receiving user and originating user A.

Alternatively, server device 11 may notify originating user A of the URL for the dedicated call-in web page that allows originating user B to participate, via originating terminal device 12A.

That is, in system 1 related to the above modified example, web page transmission unit 111 may be configured to send a URL notification web page to originating terminal device 12 of the first originating user in response to a request from originating terminal device 12 of the first originating user. This web page would notify the URL of the call-in web page, which includes communication identification information.

In this case, originating user A can view the URL notification web page displayed on originating terminal device 12A and obtain the URL of the call-in web page that he/she should notify to originating user B.

Alternatively, the URL of the dedicated call-in web page for originating user B to join the conversation may be sent to the email address of originating user B, which was provided by originating user A to server device 11.

That is, in system 1 related to the above modified example, web page transmission unit 111 may be configured to send an email address input web page to originating terminal device 12 of the first originating user in response to a request from originating terminal device 12 of the first originating user. This web page would allow the first originating user to input the email address where the URL of the call-in web page with communication identification information should be notified. Server device 11, upon receiving the email address entered by the first originating user, sends an email containing the URL of the call-in web page with communication identification information to the email address provided by the first originating user.

In this case, originating user A can input originating user B's email address into the email address input web page. This allows server device 11 to send the URL of the dedicated call-in web page, enabling originating user B to join the conversation, to originating user B via email.

(9) When the originating user and the first receiving user (hereinafter referred to as “receiving user X”) are interacting using system 1, there may be instances where the second receiving user (hereinafter referred to as “receiving user Y”) is to be added to the conversation.

As a modified example to address the above need, while receiving user X is interacting with the originating user, receiving user X may display a call-in web page on his/her receiving terminal device 13 (hereinafter referred to as “receiving terminal device 13X”) to call receiving user Y. Upon operating the “Call” button on the call-in web page to initiate the call to receiving user Y, and if receiving user Y responds to the call, server device 11 may enable communication for interaction between receiving user X and receiving user Y.

That is, in system 1, receiving terminal device 13 is equipped with a web browser function, and web page transmission unit 111, in response to a request from receiving terminal device 13 used by the first receiving user, sends a call-in web page to receiving terminal device 13 of the first receiving user. This call-in web page accepts a call operation for receiving terminal device 13 of the second receiving user. Call instruction transmission unit 114, while communication between the originating user and the first receiving user is enabled by communication enabling unit 115, sends a call instruction to receiving terminal device 13 of the second receiving user when the call operation is performed on the call-in web page displayed on receiving terminal device 13 of the first receiving user. If the second receiving user performs an operation to respond to the call on his/her receiving terminal device 13, communication enabling unit 115 enables communication for interaction between the first receiving user, using his/her receiving terminal device 13, and the second receiving user, using his/her receiving terminal device 13. This configuration allows communication between both receiving users and enables a joint interaction.

In this modified example, while receiving user X is engaged in a conversation with the originating user and maintaining the communication for the interaction, receiving user X can initiate a call to receiving user Y. If receiving user Y responds to the call, communication becomes possible between receiving user X and receiving user Y. As a result, receiving user X can request receiving user Y to join the conversation between receiving user X and the originating user.

In system 1 related to the above modified example, during the communication for interaction between the first receiving user and the second receiving user, if a three-party interaction permission notification is sent from receiving terminal device 13 of either the first receiving user or the second receiving user to notify permission for the three-party conversation, communication enabling unit 115 may enable communication for interaction between the originating user (using originating terminal device 12), the first receiving user (using his/her receiving terminal device 13), and the second receiving user (using his/her receiving terminal device 13). This configuration allows the three-party conversation to take place.

In this case, in response to a request from receiving user X, receiving user Y agrees to join the conversation between the originating user and receiving user X. Then, when receiving user X performs an operation to permit the three-party conversation on originating terminal device 12X, or when receiving user Y performs an operation to permit the three-party conversation on receiving terminal device 13Y, communication enabling unit 115 enables a three-party conversation involving the originating user, receiving user X, and receiving user Y. This allows the three-party interaction to take place.

As an alternative to the above modified example, the originating user, while interacting with receiving user X, may call receiving user Y.

That is, in system 1, receiving terminal device 13 is equipped with a web browser function. Call instruction transmission unit 114, while communication for interaction between the originating user and the first receiving user is enabled by communication enabling unit 115, sends a call instruction to receiving terminal device 13 of the second receiving user when a call operation is performed on the call-in web page displayed on originating terminal device 12. If the second receiving user responds to the call operation on his/her receiving terminal device 13, communication enabling unit 115 enables communication for interaction between the originating user (using originating terminal device 12) and the second receiving user (using his/her receiving terminal device 13). This configuration allows the conversation between the originating user and the second receiving user to take place.

In this modified example, while the originating user is engaged in a conversation with receiving user X and maintaining the communication for the interaction, the originating user can call receiving user Y. If receiving user Y responds to the call, communication becomes possible between the originating user and receiving user Y. As a result, the originating user can request receiving user Y to join the conversation between the originating user and receiving user X.

In system 1, related to the above modified example, if a three-party interaction permission notification is sent from either originating terminal device 12 or receiving terminal device 13 of the second receiving user, notifying the permission for the three-party conversation, communication enabling unit 115 may enable communication for interaction between the originating user (using originating terminal device 12), the first receiving user (using his/her receiving terminal device 13), and the second receiving user (using his/her receiving terminal device 13). This configuration allows for communication to take place among all three users for their interaction.

In this case, in response to a request from the originating user, receiving user Y agrees to join the conversation between the originating user and receiving user X. When the originating user performs an operation on originating terminal device 12, or when receiving user Y performs an operation on receiving terminal device 13Y to permit the three-party conversation, communication becomes possible for a three-party conversation among the originating user, receiving user X, and receiving user Y.

(10) As a modified example to address the need where the originating user wants to schedule a conversation with the receiving user, server device 11 could accept the originating user's reservation for a conversation with the receiving user. It would then notify the originating user of reservation identification information that identifies the reservation. When the originating user wishes to call the receiving user during the scheduled time, the originating user could input the notified reservation identification information into the call-in web page to initiate the call to the receiving user.

That is, in system 1, web page transmission unit 111 may be configured to send a reservation acceptance web page to originating terminal device 12 in response to a request from originating terminal device 12, where the originating user can reserve a time slot during which the receiving user is available to provide services. After the originating user makes the reservation on the reservation acceptance web page displayed on his/her originating terminal device 12, web page transmission unit 111 sends a reservation identification information notification web page to originating terminal device 12, notifying the originating user of the reservation identification information. The call-in web page would then accept the input of the reservation identification information, and communication enabling unit 115 would enable communication for interaction between the originating user (using originating terminal device 12) and the receiving user (using receiving terminal device 13) if the originating user inputs the reservation identification information and performs a call operation on the call-in web page, based on the current time corresponding to the scheduled reservation. This configuration allows the scheduled interaction to take place.

In this modified example, the originating user performs a reservation operation on the reservation acceptance web page displayed on originating terminal device 12. Subsequently, the originating user makes a note of the reservation identification information displayed on the reservation identification information notification web page displayed on originating terminal device 12. When the scheduled reservation time arrives, the originating user inputs the reservation identification information, which he/she had noted, into the call-in web page displayed on originating terminal device 12, and then performs an operation on the “Call” button. If the current time is within the scheduled reservation time identified by the reservation identification information sent from originating terminal device 12, server device 11 sends a call instruction to receiving terminal device 13, enabling the call to be made.

In the above modified example, the originating user receives the reservation identification information through the reservation identification information notification web page. Alternatively, an email containing the reservation identification information could be sent to the originating user's email address instead.

That is, in system 1, web page transmission unit 111 may be configured to send a reservation acceptance web page to originating terminal device 12 in response to a request from originating terminal device 12. This web page allows the originating user to input a reservation for one of the available time slots during which the receiving user can provide services, as well as the email address where the reservation identification information should be sent. If the originating user inputs the reservation and email address on the reservation acceptance web page displayed on originating terminal device 12, an email transmission unit sends an email containing the reservation identification information to the specified email address. The call-in web page then accepts the input of the reservation identification information, and communication enabling unit 115 enables communication between the originating user (using originating terminal device 12) and the receiving user (using receiving terminal device 13) if the originating user enters the reservation identification information and performs a call operation on the call-in web page, based on the current time corresponding to the scheduled reservation. This configuration allows communication for the scheduled interaction to take place.

In this modified example, the originating user can input his/her email address on the reservation acceptance web page displayed on originating terminal device 12. By doing so, he/she can receive the reservation identification information via email sent to the address. In this modified example, as in the previous one, the originating user can enter the reservation identification information on the call-in web page within the reserved time slot and, after performing the operation on the “Call” button, initiate communication with the receiving user for the scheduled interaction.

As an alternative to the two modified examples above, the URL of a dedicated call-in web page corresponding to the reservation could be notified to the originating user.

That is, in system 1, web page transmission unit 111 may be configured to send a reservation acceptance web page to originating terminal device 12 in response to a request from originating terminal device 12. If the originating user makes a reservation on the displayed reservation acceptance web page, web page transmission unit 111 sends a URL notification web page containing the URL of the call-in web page with the reservation identification information to originating terminal device 12. Then, when the originating user performs a call operation on the call-in web page (which contains the reservation identification information) displayed on originating terminal device 12, based on the current time corresponding to the reserved time, communication enabling unit 115 enables communication for interaction between the originating user (using originating terminal device 12) and the receiving user (using receiving terminal device 13). This configuration allows for the scheduled interaction between the originating user and the receiving user to take place.

In this modified example, the originating user performs a reservation operation on the reservation acceptance web page displayed on originating terminal device 12. They then make a note of the URL displayed on the URL notification web page shown on originating terminal device 12. When the scheduled reservation time arrives, the originating user enters the URL, which he/she has noted, into the browser of originating terminal device 12, displays the call-in web page, and then performs an operation on the “Call” button. If the current time falls within the scheduled reservation time identified by the reservation identification information sent from originating terminal device 12, server device 11 sends a call instruction to receiving terminal device 13, enabling the communication to take place.

In this modified example, instead of the URL of the dedicated call-in web page being notified to the originating user through the display of the URL notification web page, the URL of the dedicated call-in web page corresponding to the reservation could be sent via email to the email address specified by the originating user.

That is, in system 1, web page transmission unit 111 may be configured to send a reservation acceptance web page to originating terminal device 12 in response to a request from originating terminal device 12. If the originating user inputs a reservation and email address on the reservation acceptance web page displayed on originating terminal device 12, an email transmission unit will send an email containing the URL of the call-in web page, along with the reservation identification information, to the specified email address. Communication enabling unit 115, when the originating user inputs the reservation identification information on the call-in web page displayed on originating terminal device 12 and performs a call operation based on the current time corresponding to the reserved time, will enable communication between the originating user (using originating terminal device 12) and the receiving user (using receiving terminal device 13) for their interaction. This configuration allows the originating user to interact with the receiving user based on the reservation made via email.

In this modified example, the originating user can input his/her email address on the reservation acceptance web page displayed on originating terminal device 12. By doing so, he/she will receive an email at that address containing the URL of the dedicated call-in web page corresponding to his/her reservation. Then, within the reserved time slot, the originating user enters the URL received via email into the browser of originating terminal device 12. On the call-in web page displayed on originating terminal device 12, the originating user can perform an operation on the “Call” button to initiate communication and interact with the receiving user.

(11) As a modified example to address the need where the conversation between the originating user and the receiving user should automatically end once the set time limit is reached, system 1 may be configured as follows. In system 1, communication enabling unit 115 could include a timing mechanism that tracks the service duration provided by the receiving user to the originating user. When the service duration reaches the specified time limit, communication enabling unit 115 can disable the ongoing communication, thus automatically ending the interaction. This configuration ensures that the conversation is automatically concluded once the designated time has elapsed.

In this modified example, when the interaction time between the originating user and the receiving user reaches the preset time limit, communication for the conversation between originating terminal device 12 and receiving terminal device 13 becomes impossible, and as a result, the interaction is automatically terminated. The time setting can be performed by either the receiving user or the originating user. Alternatively, server device 11 may set a default value for the time limit. This ensures that the conversation will automatically conclude once the time limit is reached.

In the modified example described above, the remaining time available for the interaction could be notified to the originating user. Specifically, in system 1, web page transmission unit 111 may be configured to send a remaining time notification web page to originating terminal device 12. This web page would notify the originating user of the remaining time for the interaction. While the communication enabled by communication enabling unit 115 provides the service from the receiving user to the originating user, the remaining time is calculated by subtracting the elapsed service time from the preset time. This configuration ensures that the originating user is aware of how much time remains before the conversation is automatically terminated.

In this case, the originating user can easily know the remaining time for his/her conversation with the receiving user while the interaction is ongoing.

(12) As a modified example to address the need where the receiving user can provide multiple different types of services to the originating user, in system 1, web page transmission unit 111 may be configured to send the call-in web page corresponding to the type of service requested by originating terminal device 12. Web page transmission unit 111 would send the appropriate call-in web page to originating terminal device 12 based on the request from originating terminal device 12, which corresponds to one of the different types of services offered by the receiving user. Then, call instruction transmission unit 114, upon receiving the operation of the “Call” button on the call-in web page displayed on originating terminal device 12, sends a call instruction with service identification information to receiving terminal device 13. This service identification information corresponds to the specific type of service requested in the call-in web page. This configuration allows the originating user to select from multiple service types offered by the receiving user, and the correct service is initiated based on the user's selection.

In this modified example, the receiving terminal information table (refer to FIG. 3) includes an additional “Service Type Information” column, along with the existing “Terminal Identification Information,” “Address,” and “URL” columns. In the “Service Type Information” column, information indicating the type of service (service type information) corresponding to each URL stored in the “URL” column is stored. This associates each URL with the type of service identified by the respective call-in web page.

When server device 11 receives a call request from originating terminal device 12 to receiving terminal device 13, it identifies the service type information corresponding to the URL of the call-in web page that initiated the request from the receiving terminal information table. When sending the call instruction to receiving terminal device 13, server device 11 also sends the identified service type information to receiving terminal device 13.

In response to the call instruction from server device 11, receiving terminal device 13 displays a screen to call the receiving user. On this screen, the service type information is also displayed. Therefore, the receiving user can know to which type of service, out of the multiple services he/she can provide, the call is related by viewing the service type information displayed on the screen. The URL is one example of page identification information used to identify a call-in web page, and other forms of page identification information may be used. Additionally, if the page identification information indicates the type of service, the entire or part of the page identification information may be used as the service type information.

In the modified example above, if a call request for the receiving user is made by another originating user while the receiving user is already interacting with the current originating user, the system may notify the receiving user about the type of service related to the incoming call request without actually calling the receiving user.

That is, in system 1 related to the above modified example, if a call operation is performed on the call-in web page displayed by originating terminal device 12 of another originating user while communication for interaction between the receiving user and one originating user is enabled by communication enabling unit 115, call instruction transmission unit 114 may send a call notification to receiving terminal device 13. This notification would inform the receiving user of the service identification information associated with the call-in web page and notify him/her that a call request was made, instead of sending a call instruction to initiate the call.

In this case, when the receiving user is engaged in a conversation with one originating user and receives a request for interaction from another originating user, the receiving user cannot respond to the request. However, he/she can know which type of service the request pertains to, as the call notification will provide information about the service type associated with the incoming request.

(13) To avoid an inconvenience where the receiving user might receive repeated calls from malicious originating users, system 1 could include a feature where the receiving user can register the address of any originating user they do not wish to interact with in a so-called “blacklist.” In this case, the receiving user would not respond to any call requests from addresses listed in the blacklist. This approach helps protect the receiving user from unwanted interactions.

That is, in system 1, a prohibition address storage unit may be provided to store Internet addresses of the originating terminal devices of originating users who are prohibited from interacting with the receiving user. Web page transmission unit 111 would then be configured to not send a call-in web page to originating terminal device 12 of any originating user whose address is stored in the prohibition address storage unit.

Instead of the previous modified example, in system 1, a prohibition address storage unit may be provided to store Internet address of originating terminal device 12 of any originating user prohibited from interacting with the receiving user. Call instruction transmission unit 114, upon receiving a call operation on the call-in web page displayed on originating terminal device 12 whose address is stored in the prohibition address storage unit, would not send the call instruction to receiving terminal device 13.

In both of the modified examples above, the receiving user can register the address of any originating user they do not wish to interact with in server device 11. This prevents the receiving user from receiving any call requests from the registered originating user, effectively blocking unwanted interactions.

(14) To address the situation where the originating user or receiving user may want to show his/her surroundings captured by the rear-facing camera (out-camera) during a conversation, while he/she is using the front-facing camera (in-camera) to capture his/her face, a modified example can be implemented as follows. Communication enabling unit 115 allows communication for interaction between an originating user and a receiving user. During this interaction, receiving terminal device 13 can automatically switch between cameras based on the orientation of the display. Specifically, when the display is in a vertical orientation (with its long edge aligned vertically), the in-camera, located on the front side of the display, captures images, and when the display is in a horizontal orientation (with its long edge aligned horizontally), the out-camera, located on the rear side of the device, captures images.

In this modified example, the originating user or receiving user can easily switch between the in-camera and out-camera by simply changing the orientation of their device.

(15) In the present application, the term “user” is not limited to humans but also includes devices (such as robots) equipped with the functionality to interact with humans or other devices. In interactions between devices, information may be issued to the terminal device acting as the user in a form that is not interpretable by humans but can be interpreted by the device functioning as the user. When the user is a device, the terminal device used by the user may be integrally constructed with the device acting as the user. For example, if the user is a robot equipped with communication capabilities, the robot functions both as the user and as the terminal device used by the user. Additionally, when the user is a robot, an interaction where the robot's conversation partner provides instructions to the robot, and the robot responds to these instructions by performing actions such as moving, capturing surrounding images, sounds, or other information, and sending the acquired information back to the conversation partner, is also a form of interaction contemplated in the present application.

(16) In the embodiment described above, the identification information (hereinafter referred to as “page identification information”) for identifying the call-in web page (FIG. 3) on the Internet is assumed to be a URL. However, the page identification information is not limited to the URL format. Other forms of page identification information may also be used.

For example, when a request to send the call-in web page is made using the POST method, the call-in web page is not identified by a URL but by the data contained in the BODY section. In this case, the data in the BODY section serves as the page identification information.

Additionally, when a request to send the call-in web page is made using the GET method, the call-in web page is identified by the request parameters included in the URL. In this case, the call-in web page is identified by the URL, but more specifically, the request parameters contained within the URL serve as the page identification information.

(17) The call-in web page (FIG. 3) may be invoked from other web pages as well.

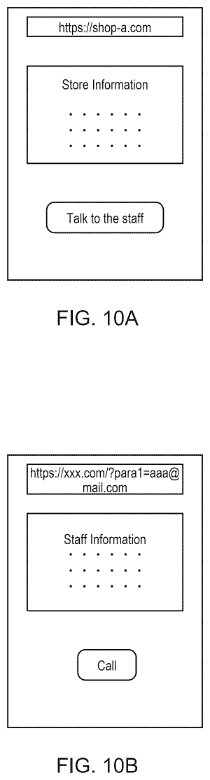

FIGS. 10A and 10B illustrate examples of screens displayed by the browser of originating terminal device 12 in one instance of this modified example. FIG. 10A represents, for example, the homepage of Shop A. The web page illustrated in FIG. 10A will be referred to as the “calling page.” The calling page can be sent from server device 11, but it may also be sent from other sources. In other words, the calling page does not necessarily have to be managed by server device 11.

The calling page includes a “Talk to Staff” button. This “Talk to Staff” button is linked to the page identification information of the call-in web page. When the originating user performs a touch operation or other action on the “Talk to Staff” button, the call-in web page, as shown in FIG. 10B, is displayed. The call-in web page is sent from server device 11.

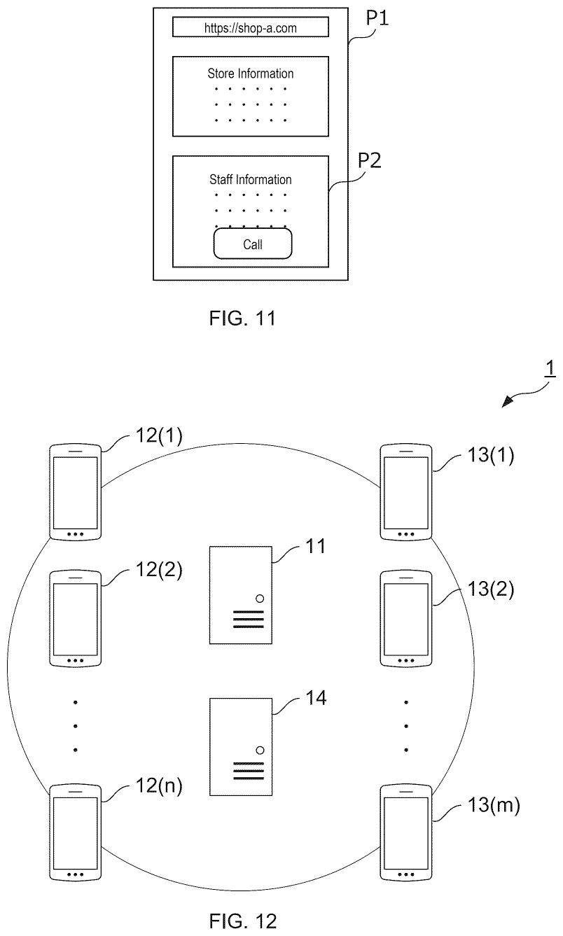

FIG. 11 illustrates an example of a screen displayed by the browser of originating terminal device 12 in another instance of this modified example. The web page shown in FIG. 11 is composed of parent page P1 and child page P2 embedded within parent page P1.

Parent page P1 could be, for example, the homepage of Shop A. Parent page P1 may be sent from server device 11, but it may also be sent from other sources. In other words, parent page P1 does not necessarily have to be managed by server device 11.

Child page P2 is the call-in web page.

When the originating user displays parent page P1 on the browser of originating terminal device 12, the script embedded in parent page P1 causes child page P2 (the call-in web page) to be retrieved from server device 11 and displayed within parent page P1. In this case, parent page P1 is the calling page.

When the originating user performs an operation on the “Call” button displayed on the call-in web page in FIG. 10B or the “Call” button displayed on child page P2 in FIG. 11, a call request containing terminal identification information linked to the “Call” button is sent from originating terminal device 12 to server device 11. Server device 11 uses the terminal identification information contained in the request received from originating terminal device 12 to send a call instruction to receiving terminal device 13.

(18) In the embodiment described above, server device 11 stores, for each receiving terminal device 13, the address (which is the information used to identify receiving terminal device 13 on the Internet), the terminal identification information (which is the information used by server device 11 to identify receiving terminal device 13), and the page identification information (which is the information used to identify the call-in web page for calling receiving terminal device 13 on the Internet, such as a URL in the example provided) in association with each other (refer to FIG. 4).

The terminal identification information is associated with an address in a one-to-one correspondence and is one example of information used to identify receiving terminal device 13 on the Internet. The terminal identification information is used as the information linked to the “Call” button displayed on the call-in web page.

The address is information that, for example, is composed of a combination of a global IP address and a port number that receiving terminal device 13 is using to connect to the Internet.

To always keep track of the latest address, it is necessary to frequently communicate with receiving terminal device 13 and obtain its current address. The processing to update this address could be performed by a server device other than server device 11.

FIG. 12 illustrates the overall configuration of system 1 according to this modified example. In this modified example, system 1 includes server device 14. Server device 14 is a server that manages the address of receiving terminal device 13.

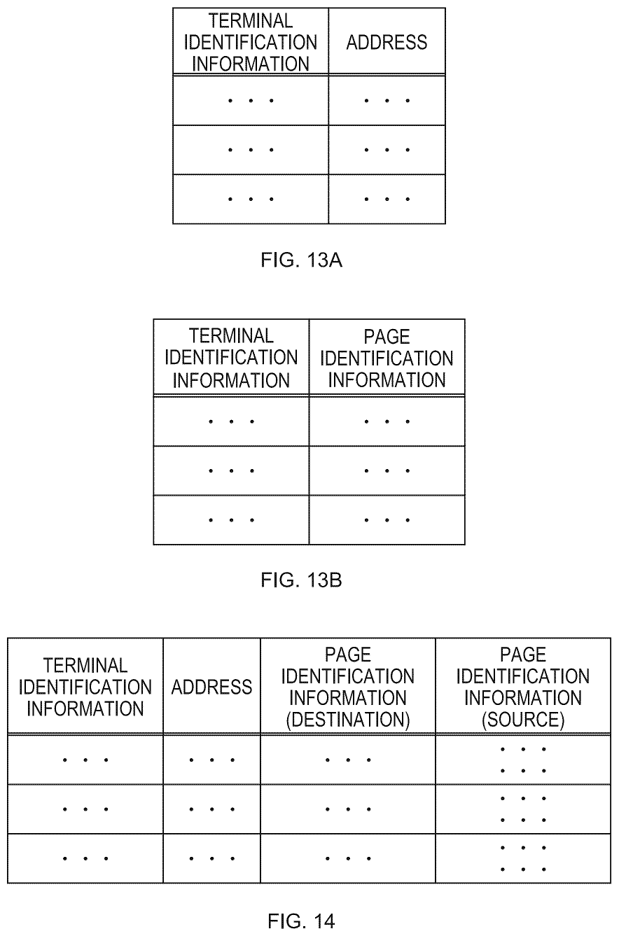

FIG. 13A illustrates the data structure of the receiving terminal information table stored by server device 14. FIG. 13B illustrates the data structure of the receiving terminal information table stored by server device 11.

Server device 14 stores the receiving terminal information table with the data structure shown in FIG. 13A (hereinafter referred to as “receiving terminal information table A”). Receiving terminal information table A stores, for each receiving terminal device 13, the terminal identification information used by server device 11 to identify receiving terminal device 13, and the address, which is the information used to identify receiving terminal device 13 on the Internet, in association with each other.

Server device 14 communicates with each receiving terminal device 13, obtains the latest address from receiving terminal device 13, and updates receiving terminal information table A with the newly acquired address.

When server device 14 receives a request from server device 11 that includes terminal identification information along with an address request, it sends the address stored in association with the terminal identification information back to server device 11.

Server device 11 stores the receiving terminal information table with the data structure shown in FIG. 13B (hereinafter referred to as “receiving terminal information table B”). Receiving terminal information table B stores, for each receiving terminal device 13, the terminal identification information and the page identification information, which is the information used to identify the call-in web page for calling the receiving terminal device 13 on the Internet, in association with each other.

When server device 11 receives a request for sending a call-in web page that includes page identification information from originating terminal device 12, it sends a call-in web page containing a “Call” button, which is linked to the terminal identification information stored in association with the page identification information, back to originating terminal device 12. Subsequently, in response to the originating user's operation on the “Call” button, server device 11 receives the call request for receiving terminal device 13 sent from originating terminal device 12. It then sends a request for the address containing the terminal identification information to server device 14. Upon receiving the address in response from server device 14, server device 11 sends a call instruction to the received address. If receiving terminal device 13 responds to the call instruction, server device 11 enables communication between originating terminal device 12 and receiving terminal device 13.

Instead of server device 11 directly sending the call instruction to receiving terminal device 13 as described above, server device 11 may send the call instruction to receiving terminal device 13 through server device 14. In this case, when server device 11 receives the call request for receiving terminal device 13 sent from originating terminal device 12 in response to the originating user's operation on the “Call” button, it sends a request to server device 14 to send the call instruction, which includes the terminal identification information contained in the request. When server device 14 receives the request to send the call instruction from server device 11, it sends the call instruction to the address stored in association with the terminal identification information included in the request. In this case, if receiving terminal device 13 responds to the call instruction, either server device 11 or server device 14 may enable communication between originating terminal device 12 and receiving terminal device 13.

In this modified example, the terminal identification information may be determined by server device 11 and notified to server device 14, or it may be determined by server device 14 and notified to server device 11.

(19) The page identification information, which is the information used to identify the call-in web page on the Internet, may be generated by server device 11 or sent from receiving terminal device 13 to server device 11. When the page identification information is sent from receiving terminal device 13 to server device 11, receiving terminal device 13 may generate the page identification information, or the page identification information may be input by the receiving user and sent from receiving terminal device 13 to server device 11.

When server device 11 receives the page identification information from receiving terminal device 13, server device 11 may check whether the newly received page identification information overlaps with existing page identification information associated with other receiving terminal devices 13. If no overlap is found, server device 11 may store the page identification information.

For example, the page identification information for the call-in web page shown in FIG. 10B could be the request parameter “aaa@mail.com” included in the URL of the call-in web page, which is “https://xxx.com/?para1=aaa@mail.com”. In this modified example, server device 11 receives “aaa@mail.com” from receiving terminal device 13 and stores it in the receiving terminal information table. In this case, “aaa@mail.com” is, for example, information input by the receiving user into receiving terminal device 13. In this case, the receiving user can decide the page identification information for the call-in web page to be used for calling him/her. In the example of FIG. 10B, the page identification information is in the form of an email address. However, the format of the page identification information is not limited to an email address format. Other formats for the page identification information may also be used.

(20) The terminal identification information, which is used to identify receiving terminal device 13 on the Internet and is linked to a virtual control (such as a “Call” button) that the originating user operates to call receiving terminal device 13 in the call-in web page, may be dynamically changed.

For example, in a case that the information linked to the “Call” button shown in FIG. 10B or FIG. 11 is currently “https://yyy.com/?para2=1234.” The request parameter “1234” included in this URL is the terminal identification information. In this case, for example, in the receiving terminal information table A (FIG. 13A) and receiving terminal information table B (FIG. 13B), the “terminal identification information” field of the data record for receiving terminal device 13 corresponding to the call-in web page shown in FIG. 10 or FIG. 11 would contain “1234.” Additionally, the “page identification information” field in receiving terminal information table B (FIG. 13B) would contain “aaa@mail.com.”

In the above state, when receiving terminal device 13 performs an operation to exit the application (the so-called Kill operation), the application sends a request to server device 11 to delete the terminal identification information before the application exits. The request to delete the terminal identification information includes the terminal identification information of receiving terminal device 13. Server device 11, in accordance with the request received from receiving terminal device 13, deletes the terminal identification information contained in the request from receiving terminal information table A. Additionally, server device 14 forwards the request received from receiving terminal device 13 to server device 14. Server device 14, in accordance with the request received from server device 11, deletes the terminal identification information contained in the request from receiving terminal information table B.

The manner in which terminal identification information is deleted may either involve completely erasing the information from memory or managing the terminal identification information stored in memory as unusable information.

Subsequently, when the application program is launched on receiving terminal device 13, in accordance with the application program, receiving terminal device 13 sends a request to server device 11 to transmit the terminal identification information. In response to the request, server device 11 searches the data record in receiving terminal information table A corresponding to the requesting receiving terminal device 13. If the terminal identification information is stored in the “terminal identification information” field, server device 11 sends the terminal identification number to receiving terminal device 13. On the other hand, if the terminal identification information has been deleted from the “terminal identification information” field, server device 11 generates a new terminal identification number (for example, “1235”) and stores the generated terminal identification number in the “terminal identification information” field. It then notifies server device 14 of the generated terminal identification number. Server device 14 stores the newly notified terminal identification number in the “terminal identification information” field of the data record in receiving terminal information table B, corresponding to the target receiving terminal device 13.

Instead of server device 11 generating a new terminal identification number and notifying server device 14, server device 14 may generate a new terminal identification number and notify server device 11.

In the above example, the request to delete the terminal identification information sent from receiving terminal device 13 to server device 11, followed by the subsequent request to send the terminal identification information from receiving terminal device 13 to server device 11, serves as a reset instruction for the terminal identification information. Alternatively, a single request from receiving terminal device 13 to server device 11 could be sent as an instruction to reset the terminal identification information. In response to this request, server device 11 (and server device 14) would perform the reset of the terminal identification information.

In the above example, the request to delete the terminal identification information is triggered by the termination of the application program on receiving terminal device 13, and the request to send the terminal identification information is triggered by the startup of the application program. However, the timing of when receiving terminal device 13 sends the instruction to reset the terminal identification information to server device 11 is not limited to the timing of the termination or startup of the application program. For example, in response to an operation performed by the receiving user on receiving terminal device 13, receiving terminal device 13 may send an instruction to reset the terminal identification information to server device 11.

Instead of sending the reset instruction to server device 11, receiving terminal device 13 may send the instruction to reset the terminal identification information to server device 14.

Instead of using the terminal identification information stored in the “terminal identification information” field of receiving terminal information table B (FIG. 13B) (for example, “1234”) as the request parameter (terminal identification information) linked to the “Call” button's URL, the information stored in the “page identification information” field (for example, “aaa@mail.com”) may also be used. In that case, the information linked to the “Call” button would be something like ‘“https://yyy.com/?para2=aaa@mail.com”’.

In this case, when server device 11 is calling receiving terminal device 13, it searches the receiving terminal information table B for the data record where the “page identification information” field contains the terminal identification information (e.g., “aaa@mail.com”) received from originating terminal device 12. Server device 11 then uses the terminal identification information (e.g., “1234”) stored in the “terminal identification information” field of the found data record to proceed with the call to receiving terminal device 13.

According to this modified example, the receiving user can reset his/her terminal identification information, which helps avoid calls from undesirable originating users (e.g., those who were previously bothersome) and prevents the misuse of terminal identification information.

(21) When the call-in web page is invoked from another web page, server device 11 may only send the call-in web page to originating terminal device 12 if the calling web page is a web page that has been registered with server device 11.

FIG. 14 illustrates the data structure of the receiving terminal information table stored by server device 11 in this modified example. In this modified example, the receiving terminal information table stores the page identification information (destination) and page identification information (source) in association with terminal identification information and the address. The page identification information (destination) is the information used to identify the call-in web page on the internet. For example, it could be “aaa@mail.com” found in the URL of the call-in web page shown in FIG. 10B. The page identification information (source) is the information used to identify the web page from which the call-in web page is invoked on the internet. For example, it could be the URL “https://shop-a.com” of the homepage shown in FIG. 10A.

In the receiving terminal information table, the “page identification information (source)” field may store multiple page identification information entries.

When server device 11 receives a request for sending the call-in web page from originating terminal device 12, it compares the page identification information of the calling web page (e.g., the URL of the calling web page) associated with the request with the page identification information stored in the “page identification information (source)” field of the corresponding data record in the receiving terminal information table for the requested call-in web page. If the page identification information of the calling web page associated with the request matches the one stored in the “page identification information (source)” field, the comparison is successful. In that case, server device 11 sends the call-in web page to originating terminal device 12 in response to the request. On the other hand, if the page identification information in the “page identification information (source)” field does not match the page identification information of the calling web page associated with the request, the comparison fails. In that case, server device 11 does not send the call-in web page in response to the request. Instead, it sends an error message, for example, to originating terminal device 12 that sent the request.

Alternatively, or in addition to the above process, when the originating user performs a call operation on the call-in web page and server device 11 receives a call request for receiving terminal device 13 from originating terminal device 12, server device 11 may compare the page identification information of the calling web page previously received from originating terminal device 12 with the page identification information stored in the “page identification information (source)” field of the data record in the receiving terminal information table corresponding to the terminal identification information included in the call request.

In that case, server device 11 sends a call instruction to receiving terminal device 13 in response to the call request only if the comparison is successful.

According to this modified example, receiving user will not be called from a call-in web page that has transitioned from an unwanted web page or from a call-in web page embedded in an unwanted web page. This ensures that the receiving user is not called in such cases, which is desirable.

(22) Server device 11 may send a call-in web page containing a control element (such as a “Call” button) that accepts the operation to call each of receiving terminal devices 13 to originating terminal device 12.

In this modified example, receiving terminal devices 13 managed in the receiving terminal information table are divided into multiple groups. As a method of grouping, for example, receiving terminal devices 13 that have matching parts of the page identification information after the “@” symbol (such as the “@mail.com” part in “aaa@mail.com”) can be grouped together. However, this method is not limited to this approach, and other methods of grouping may also be used.

In this modified example, originating terminal device 12 sends a request to server device 11 to transmit a call-in web page, which includes group identification information (such as “@mail.com”) to identify one of the groups of receiving terminal devices 13. In response to the request, server device 11 extracts the terminal identification information of one or more receiving terminal devices 13 identified by the group identification information included in the request from the receiving terminal information table. Server device 11 then generates a call-in web page containing a “Call” button for each extracted terminal identification information and sends the generated call-in web page to originating terminal device 12.

The originating user can interact with one of the “Call” buttons displayed on the call-in web page (for example, the “Call” button corresponding to the receiving user they wish to have a conversation with). By performing an operation on the desired “Call” button, he/she can initiate a conversation with the corresponding receiving user.

1. A system comprising:
a web page transmission unit that, in response to a request from an originating terminal device equipped with a web browser function used by an unspecified originating user, transmits a call-in web page to the originating terminal device, which accepts a call operation directed to a receiving terminal device equipped with a telephone function used by the receiving user,
a call instruction transmission unit that, when a call operation is performed by the originating user on the call-in web page displayed by the originating terminal device, transmits a call instruction to the receiving terminal device to initiate a call for the receiving user, and
a communication enabling unit that, when the receiving user performs an operation to answer the call on the receiving terminal device being called in the same manner as a calling method used by the telephone function, enables communication for a conversation between the originating user using the originating terminal device and the receiving user using the receiving terminal device.

2. The system according to claim 1, wherein
payment information for settlement of a fee is transmitted from the receiving terminal device to the originating terminal device via the communication enabled by the communication enabling unit, and
payment completion information, which indicates that a payment for a service provided by the receiving user to the originating user or a service requested by the originating user from the receiving user has been completed, is transmitted to the receiving terminal device via the communication enabled by the communication enabling unit.

3. The system according to claim 1, wherein
payment information for settlement of a fee for a service provided by the receiving user to the originating user or a service requested by the originating user from the receiving user is transmitted to the receiving terminal device via communication enabled by the communication enabling unit.

4. The system according to claim 1, wherein
the web page transmission unit transmits a payment page displaying payment information for settlement of a fee for a service provided by the receiving user to the originating user or a service requested by the originating user from the receiving user to the originating terminal device via the communication enabled by the communication enabling unit,
the system further comprises a payment completion information reception unit that receives payment completion information from the originating terminal device, indicating that a payment has been completed using the payment information, and
the call instruction transmission unit transmits the call instruction when the payment completion information reception unit has received the payment completion information.

5. The system according to claim 1, wherein
the web page transmission unit transmits a payment information request web page that asks for an input of payment information for settlement of a fee,
the system further comprises a payment information reception unit that receives the payment information from the originating terminal device, and
the system further comprises a payment unit that performs payment processing with an external device by communicating with the external device and carrying out the payment processing for a service provided by the receiving user to the originating user or a service requested by the originating user from the receiving user via communication enabled by the communication enabling unit.

6. The system according to claim 5, wherein
the call instruction transmission unit transmits the call instruction after the payment unit has completed the payment processing for the service with the external device.

7. The system according to claim 5, further comprising:
a timing unit that measures a duration of time of provision of the service,
wherein
the payment unit performs the payment processing for a fee for the service based on the time measured by the timing unit.

8. The system according to claim 1 wherein
the web page transmission unit, when receiving a request to transmit the call-in web page from the originating terminal device during a specified time period, transmits to the originating terminal device, instead of the call-in web page, a time-out notification web page notifying that the time period is not available for a call to the receiving terminal device to be made.

9. The system according to claim 1 further comprising:
a status information receiving unit that receives status information from the receiving terminal device indicating whether or not the receiving user is capable of providing a service,
wherein
the web page transmission unit, based on the status information received by the status information receiving unit, transmits, instead of the call-in web page, an interaction-unavailable notification web page notifying that the receiving user is unable to provide the service during a time when the receiving user is incapable of providing the service.

10. The system according to claim 1 wherein
the web page transmission unit, when receiving a request for transmitting the call-in web page from an originating terminal device used by an originating user while communication between another originating user and the receiving user is possible through the communication enabling means, transmits, instead of the call-in web page, an interaction-in-progress notification web page notifying that the receiving user is currently in a conversation with another originating user, to the originating terminal device from which the request is transmitted.

11. The system according to claim 1 wherein
the call instruction transmission unit, when communication between an originating user and the receiving user is enabled by the communication enabling unit and a call operation is performed on a call-in web page displayed by an originating terminal device of another originating user, transmits a call notification to the receiving terminal device notifying that a call request has been made, instead of transmitting a call instruction corresponding to the call operation.

12. The system according to claim 1 wherein
the call-in web page accepts an input of authentication information,
the call instruction transmission unit, when communication between a first originating user and the receiving user is enabled by the communication enabling unit, transmits a call instruction including authentication information to the receiving terminal device when the authentication information is input and a call operation is performed on the call-in web page displayed by an originating terminal device of a second originating user, and
the communication enabling unit, when an operation is performed by the receiving user on the receiving terminal device, which displays the authentication information and performs a call in accordance with the call instruction including the authentication information, enables communication for interaction among the first originating user using an originating terminal device of the first originating user, the second originating user using the originating terminal device of the second originating user, and the receiving user using the receiving terminal device.

13. The system according to claim 1 wherein
the call-in web page accepts an input of authentication information, and
the communication enabling unit, when an input of authentication information and a call operation are performed on the call-in web page displayed by an originating terminal device of a second originating user while communication for interaction between a first originating user and the receiving user is enabled by the communication enabling means, enables communication for interaction among the first originating user using an originating terminal device of the first originating user, the second originating user using the originating terminal device of the second originating user, and the receiving user using the receiving terminal device.

14. The system according to claim 12 wherein
the authentication information is transmitted from the receiving terminal device to the originating terminal device of the first originating user through the communication for interaction enabled between the first originating user and the receiving user by the communication enabling unit.

15. The system according to claim 12 wherein
the web page transmission unit, in response to a request from the originating terminal device of the first originating user, transmits an authentication information notification web page, which notifies the authentication information to be input into the call-in web page, to the originating terminal device of the first originating user.

16. The system according to claim 12 wherein
the web page transmission unit, in response to a request from the originating terminal device of the first originating user, transmits an email address input web page, which accepts an input of an email address as a notification destination for the authentication information to be input into the call-in web page, to the originating terminal device of the first originating user, and
the system further comprises an email transmission unit, which transmits an email notifying the authentication information to be input into the call-in web page to the email address input by the first originating user on the email address input web page displayed on the originating terminal device of the first originating user.

17. The system according to claim 1 wherein
the web page transmission unit transmits a call-in web page, including communication identification information for identifying the communication enabled by the communication enabling unit for interaction between a first originating user and the receiving user, to an originating terminal device of a second originating user in response to a request from the originating terminal device of the second originating user, and
the communication enabling unit, when a call operation is performed on the call-in web page including the communication identification information displayed on the originating terminal device of the second originating user while communication for interaction between the first originating user and the receiving user is enabled by the communication enabling unit, enables communication for interaction among the first originating user using an originating terminal device of the first originating user, the second originating user using the originating terminal device of the second originating user, and the receiving user using the receiving terminal device.

18. The system according to claim 17 wherein
a URL of the call-in web page including the communication identification information is transmitted from the receiving terminal device to the originating terminal device of the first originating user via the communication for interaction between the first originating user and the receiving user enabled by the communication enabling unit.

19. The system according to claim 17 wherein
the web page transmission unit transmits a URL notification web page, which notifies the URL of the call-in web page including the communication identification information, to the originating terminal device of the first originating user in response to a request from the originating terminal device of the first originating user.

20. The system according to claim 17 wherein
the web page transmission unit transmits an email address input web page, which accepts an input of an email address as a notification destination for the URL of the call-in web page including the communication identification information, to the originating terminal device of the first originating user in response to a request from the originating terminal device of the first originating user, and
the system further comprises an email transmission unit, that transmits an email notifying the URL of the call-in web page including the communication identification information to an email address input by the first originating user on the email address input web page displayed on the originating terminal device of the first originating user.

21. The system according to claim 1 utilized by a plurality of receiving users,
the web page transmission unit transmits the call-in web page including terminal identification information of a receiving terminal device of a receiving user who responded to a request from the originating terminal device,
the system further comprises storage unit that stores, for each of the plurality of receiving terminal devices, a correspondence between terminal identification information of the receiving terminal device and an address of the receiving terminal device on the Internet, and
the call instruction transmission unit transmits the call instruction to an address stored in the storage unit, corresponding to terminal identification information associated with the call-in web page for which a call operation is performed by the originating user.

22. The system according to claim 21 wherein
each of the plurality of receiving terminal devices includes a web browser function,
the web page transmission unit transmits, in response to a request from a receiving terminal device of a first receiving user, the call-in web page, which accepts a call operation for a receiving terminal device used by a second receiving user, to the receiving terminal device of the first receiving user,
the call instruction transmission unit, when a call operation for the second receiving user is performed on the call-in web page displayed on the receiving terminal device of the first receiving user while communication for interaction between the originating user and the first receiving user is enabled by the communication enabling unit, transmits a call instruction to the receiving terminal device of the second receiving user, and
the communication enabling unit, when the second receiving user performs an operation to respond to a call performed by the receiving terminal device of the second receiving user in accordance with the call instruction, enables communication for interaction between the first receiving user using the receiving terminal device of the first receiving user and the second receiving user using the receiving terminal device of the second receiving user.

23. The system according to claim 22 wherein
the communication enabling unit, when a three-party interaction permission notification notifying permission for a three-party interaction is transmitted from the receiving terminal device of the first receiving user or the receiving terminal device of the second receiving user in the communication for interaction between the first receiving user and the second receiving user enabled by the communication enabling unit, enables communication for interaction among the originating user using the originating terminal device, the first receiving user using the receiving terminal device of the first receiving user, and the second receiving user using the receiving terminal device of the second receiving user.

24. The system according to claim 21 wherein
each of the plurality of receiving terminal devices includes a web browser function,
the call instruction transmission unit, when a call operation is performed on the call-in web page of a second receiving user displayed on the originating terminal device while communication for interaction between the originating user and a first receiving user is enabled by the communication enabling unit, transmits a call instruction to a receiving terminal device of the second receiving user, and
the communication enabling unit, when the second receiving user performs an operation to respond to a call performed by the receiving terminal device of the second receiving user in accordance with the call instruction, enables communication for interaction between the originating user using the originating terminal device and the second receiving user using the receiving terminal device of the second receiving user.

25. The system according to claim 24 wherein
the communication enabling unit, when a three-party interaction permission notification notifying permission for a three-party interaction is transmitted from the origination terminal device or the receiving terminal device of the second receiving user in the communication for interaction between the originating user and the second receiving user enabled by the communication enabling unit, enables communication for interaction among the originating user using the originating terminal device, the first receiving user using the receiving terminal device of the first receiving user, and the second receiving user using the receiving terminal device of the second receiving user.

26. The system according to claim 1 wherein
the web page transmission unit transmits a reservation acceptance web page, which accepts a reservation for a time slot during which the receiving user is available to provide a service, to the originating terminal device in response to a request from the originating terminal device,
the web page transmission unit, when a reservation is performed by the originating user on the reservation acceptance web page displayed on the originating terminal device, transmits a reservation identification information notification web page, which notifies reservation identification information identifying the reservation, to the originating terminal device,
the call-in web page accepts an input of reservation identification information, and
the communication enabling unit, when reservation identification information corresponding to a current time and a call operation are performed on the call-in web page displayed on the originating terminal device, enables communication for interaction between the originating user using the originating terminal device and the receiving user using the receiving terminal device.

27. The system according to claim 1 wherein
the web page transmission unit transmits a reservation acceptance web page, which accepts a reservation for a time slot during which the receiving user is available to provide a service and an input of an email address as a notification destination for reservation identification information identifying the reservation, to the originating terminal device in response to a request from the originating terminal device,
the system further comprises an email transmission unit, when a reservation and an input of an email address are performed by the originating user on the reservation acceptance web page displayed on the originating terminal device, transmits an email, which notifies reservation identification information identifying the reservation, to an email address input on the reservation acceptance web page,
the call-in web page accepts an input of reservation identification information, and
the communication enabling unit, when reservation identification information corresponding to a current time and a call operation are performed on the call-in web page displayed on the originating terminal device, enables communication for interaction between the originating user using the originating terminal device and the receiving user using the receiving terminal device.

28. The system according to claim 1 wherein
the web page transmission unit transmits a reservation acceptance web page, which accepts a reservation for a time slot during which the receiving user is available to provide a service, to the originating terminal device in response to a request from the originating terminal device,
the web page transmission unit, when a reservation is performed by the originating user on the reservation acceptance web page displayed on the originating terminal device, transmits a URL notification web page notifying a URL of the call-in web page including reservation identification information identifying the reservation, to the originating terminal device, and
the communication enabling unit, when a call operation is performed on the call-in web page including reservation identification information corresponding to a current time displayed on the originating terminal device, enables communication for interaction between the originating user using the originating terminal device and the receiving user using the receiving terminal device.

29. The system according to claim 1 wherein
the web page transmission unit transmits a reservation acceptance web page, which accepts a reservation for a time slot during which the receiving user is available to provide a service, to the originating terminal device in response to a request from the originating terminal device,
the system further comprises an email transmission unit that transmits, when a reservation and an input of an email address have been performed by the originating user on the reservation acceptance web page displayed on the originating terminal device, transmits an email notifying a URL of the call-in web page including reservation identification information identifying the reservation to the email address, and
the communication enabling unit, when a call operation is performed on the call-in web page including reservation identification information corresponding to a current time displayed on the originating terminal device, enables communication for interaction between the originating user using the originating terminal device and the receiving user using the receiving terminal device.

30. The system according to claim 1 further comprising:
a timing unit that measures a duration of time during of provision of a service from the receiving user to the originating user via the communication enabled by the communication enabling unit,
wherein
the communication enabling unit, when the time measured by the timing unit reaches a predetermined time, disables the communication that is currently enabled.

31. The system according to claim 30 wherein
the web page transmission unit transmits a remaining time notification web page notifying a remaining time obtained by subtracting the time measured by the timing unit from the predetermined time, to the originating terminal device, during a period in which the receiving user provides a service to the originating user via the communication enabled by the communication enabling unit.

32. The system according to claim 1 wherein
the receiving user provides call-in web pages corresponding to each of different types of services,
the web page transmission unit transmits, a call-in web page corresponding to a request from the originating terminal device, from among the call-in web pages corresponding to the different types of services provided by the receiving user, to the originating terminal device, and
the call instruction transmission unit, when a call operation is performed by the originating user on the call-in web page displayed on the originating terminal device, transmits a call instruction including service identification information identifying a type of service corresponding to the call-in web page, to the receiving terminal device.

33. The system according to claim 32 wherein
the call instruction transmission unit, when a call operation is performed on the call-in web page displayed on the originating terminal device of an originating user while communication for interaction between another originating user and the receiving user is enabled by the communication enabling unit, transmits a call notification notifying the service identification information associated with the call-in web page and that a call request has been made, to the receiving terminal device, instead of transmitting a call instruction corresponding to the call operation.

34. The system according to claim 1 further comprising:
a storage unit that stores addresses on the Internet of originating terminal devices of originating users prohibited from interacting with the receiving user,
wherein
the web page transmission unit does not transmit the call-in web page to any originating terminal device whose address is stored in the storage unit.

35. The system according to claim 1 further comprising:
a storage unit that stores addresses on the Internet of originating terminal devices of originating users prohibited from interacting with the receiving user,
wherein
the call instruction transmission unit, when a call operation is performed on the call-in web page displayed on an originating terminal device whose address is stored in the storage unit, does not transmit a call instruction for the receiving user to the receiving terminal device.

36. The system according to claim 1 further comprising the receiving terminal device, wherein
the receiving terminal device performs imaging using an in-camera arranged on a surface side of a display of the receiving terminal device when the display is oriented such that a longitudinal direction of the display aligns with a vertical direction, and performs imaging using an out-camera arranged on a rear side of the display when the display is oriented such that a longitudinal direction of the display aligns with a horizontal direction, during a period in which communication for interaction between any originating user and the receiving user is enabled by the communication enabling unit.

37. The system according to claim 1 further comprising:
a reception unit that receives page identification information from the receiving terminal device, the page identification information being information for identifying the call-in web page on the Internet; and
a storage unit that stores the page identification information received by the reception unit,
wherein
the web page transmission unit transmits the call-in web page identified on the Internet by the page identification information stored in the storage unit to the originating terminal device.

38. The system according to claim 37 wherein
the reception unit receives the page identification information input by the receiving user on the receiving terminal device.

39. The system according to claim 1 further comprising:
a storage unit that stores page identification information identifying the call-in web page on the internet, and terminal identification information identifying the receiving terminal device on the internet, in association, and
a reception unit that receives an instruction for resetting the terminal identification information from the receiving terminal device,
wherein
the storage unit, in accordance with the instruction received by the reception unit, stores new terminal identification information in association with the page identification information, and
the call instruction transmission unit transmits the call instruction to the receiving terminal device using the terminal identification information stored in the storage unit.

40. The system according to claim 39 wherein
the reception unit receives, as the instruction for resetting the terminal identification information, a request for deletion of the terminal identification information and a request for transmission of the terminal identification information, from the receiving terminal device at different timings,
the storage unit, when the reception unit receives the request for deletion of the terminal identification information, deletes the terminal identification information stored in the storage unit, and
the storage unit, when the reception unit receives the request for transmission of the terminal identification information and the terminal identification information has been deleted, stores the new terminal identification information in association with the page identification information.

41. The system according to claim 1 further comprising:
a storage unit that stores first page identification information identifying a source web page of the call-in web page on the Internet, and second page identification information identifying the call-in web page on the internet, in association,
a reception unit that receives, from the originating terminal device, a request for transmission of the call-in web page, the request including third page identification information identifying a web page on the internet that generated the request; and
a page identification information comparison unit that compares the first page identification information and the third page identification information,
wherein
the web page transmission unit transmits the call-in web page identified on the internet by the second page identification information to the originating terminal device only when the comparison between the first page identification information and the third page identification information by the page identification information comparison unit is successful.

42. The system according to claim 1 further comprising:
a storage unit that stores first page identification information identifying a source web page of the call-in web page on the Internet, and terminal identification information identifying the receiving terminal device on the Internet, in association,
a reception unit that receives, from the originating terminal device, a request for transmission of the call-in web page, the request including second page identification information identifying a web page on the internet that generated the request; and
a page identification information comparison unit that compares the first page identification information and the second page identification information,
wherein
the call instruction unit transmits the call instruction to the receiving terminal device using the terminal identification information only when the comparison between the first page identification information and the second page identification information by the page identification information comparison unit is successful.

43. The system according to claim 1 utilized by a plurality of receiving users, wherein
the web page transmission unit transmits the call-in web page, which accepts call operations for each of a plurality of receiving terminal devices corresponding to the plurality of receiving users, to the originating terminal device in response to a request from the originating terminal device.

44. The system according to claim 13 wherein
the authentication information is transmitted from the receiving terminal device to the originating terminal device of the first originating user through the communication for interaction enabled between the first originating user and the receiving user by the communication enabling unit.

45. The system according to claim 13 wherein
the web page transmission unit, in response to a request from the originating terminal device of the first originating user, transmits an authentication information notification web page, which notifies the authentication information to be input into the call-in web page, to the originating terminal device of the first originating user.

46. The system according to claim 13 wherein
the web page transmission unit, in response to a request from the originating terminal device of the first originating user, transmits an email address input web page, which accepts an input of an email address as a notification destination for the authentication information to be input into the call-in web page, to the originating terminal device of the first originating user, and
the system further comprises an email transmission unit, which transmits an email notifying the authentication information to be input into the call-in web page to the email address input by the first originating user on the email address input web page displayed on the originating terminal device of the first originating user.
